(19) United States
(12) Patent Application Publication
(10) Pub. No.: US 2018/0187969 A1
(43) Pub. Date: Jul. 5, 2018

(54) REFRIGERATOR

(71) Applicant: SAMSUNG ELECTRONICS CO., LTD., Suwon-si (KR)

(72) Inventors: Jung Yeob KIM, Suwon-si (KR); Na Jeong HAN, Suwon-si (KR)

(73) Assignee: SAMSUNG ELECTRONICS CO., LTD., Suwon-si (KR)

(21) Appl. No.: 15/861,271

(22) Filed: Jan. 3, 2018

Related U.S. Application Data
(60) Provisional application No. 62/441,787, filed on Jan. 3, 2017.

(30) Foreign Application Priority Data
Dec. 15, 2017 (KR) 10-2017-0173017

(51) Int. Cl. F25D 29/00; H04L 29/08; G06F 3/0488; G06F 3/0482; H04W 4/70; G06F 3/041; H04W 4/80

(52) U.S. Cl. CPC F25D 29/005; H04L 67/12; G06F 3/04883; F25D 2400/361; H04W 4/70; G06F 3/0416; H04W 4/80; G06F 3/0482

(57) ABSTRACT

Disclosed herein is a refrigerator including a touchscreen display configured to receive a touch input from a plurality of users and display content in response to the touch input, a storage configured to store content for each of the plurality of users, and a controller configured to sense any one of the plurality of users and display content for the user on the touchscreen display in response to the sensing of the user, wherein the controller displays a different piece of content on the touchscreen display in response to sensing of another user.

### CROSS-REFERENCE TO RELATED APPLICATION

This application claims the benefit of U.S. Provisional Application No. 62/441,787 filed on Jan. 3, 2017 and Korean Patent Application No. 10-2017-0173017, filed on Dec. 15, 2017 in the Korean Intellectual Property Office, the disclosure of which is incorporated herein by reference.

### BACKGROUND

### 1. Field

Embodiments of the present disclosure relate to a refrigerator, and more particularly, to a refrigerator capable of communicating with an external device.

### 2. Description of the Related Art

Nowadays, a refrigerator includes a display configured to display temperature of a storage compartment and an operation mode of the refrigerator.

Such a display not only uses a graphical user interface for a user to easily acquire image information but also uses a touch panel for the user to intuitively input a control command. In other words, nowadays, a display performs an information input function as well as an information display function.

Furthermore, nowadays, a refrigerator includes a communication module configured to be connected to an external device (for example, a server connected to the Internet).

Through the communication module, the refrigerator may connect to the Internet, acquire various pieces of information from various servers connected to the Internet, and provide various services on the basis of the acquired information. For example, the refrigerator may be linked to a user device and display various pieces of content such as a memo, a schedule, a sketch, and things to do.

In this way, the refrigerator offers wider variety of services to a user through the display and the communication module.

### SUMMARY

Therefore, it is an aspect of the present disclosure to provide content customized for each of a plurality of users by using a communication device and a touchscreen display linked to user devices of the plurality of users.

It is another aspect of the present disclosure to provide a refrigerator capable of providing different pieces of content to different users by using a communication device and a touchscreen display.

Additional aspects of the disclosure will be set forth in part in the description which follows and, in part, will be obvious from the description, or may be learned by practice of the disclosure.

In accordance with one aspect of the present disclosure, a refrigerator includes a touchscreen display configured to receive a touch input from a plurality of users and display content in response to the touch input, a storage configured to store content for each of the plurality of users, and a controller configured to sense any one of the plurality of users and, display content for the user on the touchscreen display in response to the sensing of the user, wherein the controller displays a different piece of content on the touchscreen display in response to sensing of another user.

The refrigerator may further include a microphone configured to receive a voice signal of the plurality of users and output an electrical signal corresponding to the voice signal, and the controller may identify any one of the plurality of users on the basis of the electrical signal from the microphone.

The content may include memos, recipients of the memos, and senders of the memos, and the controller may display a memo of which a recipient or sender matches the user on the touchscreen display in response to the sensing of the user.

The content may include things to do and performers of the things to do, and the controller may display things to do of which a performer matches the user on the touchscreen display in response to the sensing of the user.

The content may include sketches and writers of the sketches, and the controller may display a sketch of which a writer matches the user on the touchscreen display in response to the sensing of the user.

The content may include schedules, writers of the schedules, and participants in the schedules and the controller may display a schedule of which a writer or a participant matches the user on the touchscreen display in response to the sensing of the user.

The content may include at least one of weather information, schedule information, and news information, and the controller may display a piece of content selected by the user among the weather information, the schedule information, and the news information on the touchscreen display in response to the sensing of the user.

The refrigerator may further include an audio configured to output sound, and the controller may control the audio to output content selected by the user by sound.

The refrigerator may further include a communicator configured to communicate with a user device of each of the plurality of users, and the controller may transmit pieces of content for the plurality of users to the user devices of the plurality of users through the communicator.

The controller may transmit a different piece of content to a user device of another user through the communicator.

In accordance with another aspect of the present disclosure, a refrigerator includes a touchscreen display configured to display an image in response to a touch input of a first user and display content in response to a touch input of a second user, a storage configured to store user information of the first user and user information of the second user, and a controller configured to generate content related to the second user according to the touch input of the first user and display the user information of the second user and the content related to the second user on the touchscreen display.

The controller may further generate content related to the first user according to the touch input of the first user and display the content related to the second user and the content related to the first user on the touchscreen display in response to sensing of the first user or the second user.

The controller may generate content related to the first user according to the touch input of the first user, display the content related to the first user in response to sensing of the first user, and display content related to the second user in response to sensing of the second user.

The refrigerator may further include a communicator configured to communicate with a user device of the first user on the basis of the user information of the first user and communicate with a user device of the second user on the basis of the user information of the second user, and the controller may generate content related to the first user according to the touch input of the first user and transmit the content related to the first user and the content related to second user to the user device of the first user and the user device of the second user.

The refrigerator may further include a communicator configured to communicate with a user device of the first user on the basis of the user information of the first user and communicate with a user device of the second user on the basis of the user information of the second user, and the controller may generate content related to the first user according to the touch input of the first user, transmit the content related to the first user to the user device of the first user, and transmit the content related to the second user to the user device of the second user.

In accordance with still another aspect of the present disclosure, a method of controlling a refrigerator includes receiving a touch input from a first user, generating content related to a second user according to the touch input, and displaying a user image showing the first user, a user image showing the second user, and the content related to the second user.

The method may further include generating content related to the first user according to the touch input of the first user, and displaying the content related to the second user and the content related to the first user in response to sensing of the first user or the second user.

The method may further include generating content related to the first user according to the touch input of the first user, displaying the content related to the first user in response to sensing of the first user, and displaying the content related to the second user in response to sensing of the second user.

The method may further include generating content related to the first user according to the touch input of the first user, and transmitting the content related to the first user and the content related to the second user to a user device of the first user and a user device of the second user.

The method may further include generating content related to the first user according to the touch input of the first user, transmitting the content related to the first user to a user device of the first user, and transmitting the content related to the second user to a user device of the second user.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates an exterior of a refrigerator according to one embodiment;

FIG. 2 illustrates a front view of the refrigerator according to one embodiment;

FIG. 3 illustrates a configuration of the refrigerator according to one embodiment;

FIG. 4 illustrates a touchscreen display included in the refrigerator according to one embodiment;

FIG. 5 illustrates an example in which the refrigerator according to one embodiment communicates with external devices;

FIG. 6 illustrates an exterior of a user device according to one embodiment;

FIG. 7 illustrates a configuration of the user device according to one embodiment;

FIG. 8 illustrates a home screen displayed on the touchscreen display included in the refrigerator according to one embodiment;

FIG. 9 illustrates a method of adding a user to the refrigerator according to one embodiment;

FIGS. 10, 11, and 12 illustrate screens for adding a user by using the method of adding a user illustrated in FIG. 9;

FIG. 13 illustrates a method of displaying another screen with respect to another user by the refrigerator according to one embodiment;

FIG. 14 illustrates another home screen displayed on the touchscreen display included in the refrigerator according to one embodiment;

FIG. 15 illustrates a method of generating and displaying a memo by the refrigerator according to one embodiment;

FIGS. 16, 17, 18, and 19 illustrate examples of screens for generating and displaying a memo according to the method of generating and displaying a memo illustrated in FIG. 15;

FIG. 20 illustrates another example of a memo display screen displayed on the touchscreen display included in the refrigerator according to one embodiment;

FIG. 21 illustrates a method of generating and displaying things to do, by the refrigerator according to one embodiment;

FIGS. 22, 23, 24, and 25 illustrate screens for generating and displaying things to do according to the method of generating and displaying things to do illustrated in FIG. 21;

FIG. 26 illustrates another example of a things-to-do display screen displayed on the touchscreen display included in the refrigerator according to one embodiment;

FIG. 27 illustrates a method of generating and displaying a sketch by the refrigerator according to one embodiment;

FIGS. 28, 29, 30, and 31 illustrate screens for generating and displaying a sketch according to the method of generating and displaying a sketch illustrated in FIG. 27;

FIG. 32 illustrates another example of a sketch display screen displayed on the touchscreen display included in the refrigerator according to one embodiment;

FIG. 33 illustrates a method of generating and displaying a schedule by the refrigerator according to one embodiment;

FIGS. 34, 35, and 36 illustrate screens for generating and displaying a schedule according to the method of generating and displaying a schedule illustrated in FIG. 33;

FIG. 37 illustrates another example of a schedule display screen displayed on the touchscreen display included in the refrigerator according to one embodiment;

FIG. 38 illustrates a method of generating and displaying a shopping list by the refrigerator according to one embodiment;

FIGS. 39, 40, 41, and 42 illustrate screens for generating and displaying a shopping list according to the method of generating and displaying a shopping list illustrated in FIG. 38;

FIG. 43 illustrates a method of generating and displaying a food list by the refrigerator according to one embodiment;

FIGS. 44, 45, 46, 47, and 48 illustrate screens for generating and displaying a food list according to the method of generating and displaying a food list illustrated in FIG. 43;

FIG. 49 illustrates a method of providing morning briefing by the refrigerator according to one embodiment;

FIG. 50 illustrates a morning briefing screen displayed on the touchscreen display included in the refrigerator according to one embodiment;

FIGS. 51, 52, 53, and 54 illustrate screens for setting morning briefing of the refrigerator according to one embodiment;

FIG. 55 illustrates a morning briefing output screen for outputting morning briefing by the refrigerator according to one embodiment; and

FIGS. 56 and 57 illustrate other examples of a briefing display screen displayed on the touchscreen display included in the refrigerator according to one embodiment.

### DETAILED DESCRIPTION

Like reference numerals refer to like elements throughout. Not all elements of embodiments are described herein, and general content in an art to which the disclosure pertains or overlapping content between embodiments will be omitted. Terms such as “part,” “module,” “member,” and “block,” when used herein, may be implemented by software or hardware. According to embodiments, a plurality of “parts,” “modules,” “members,” or “blocks” may be implemented as a single element, or a single “part,” “module,” “member,” or “block” may include a plurality of elements.

Throughout the specification, when a certain part is described as being “connected” to another part, both a case in which the certain part is indirectly connected to the other part as well as a case in which the certain part is directly connected to the other part are included therein, and the indirect connection includes a connection via a wireless communication network.

When a certain part is described as “including” a certain element, this signifies that the certain part may also include another element rather than excluding the other element unless particularly described otherwise.

Throughout the specification, when a certain member is described as being “on” another member, both a case in which still another member is present between the two members as well as a case in which the certain member is in contact with the other member are included therein.

Terms such as “first” and “second” are used to distinguish one element from another element, and an element is not limited by the above-mentioned terms.

A singular expression includes a plural expression unless context clearly indicates otherwise.

Reference numerals for steps are used for convenience of description and are not intended to describe an order of the steps. The steps may be performed in a different order from the stated order unless context clearly describes a specific order.

Hereinafter, the principles and embodiments of the present disclosure will be described with reference to the accompanying drawings.

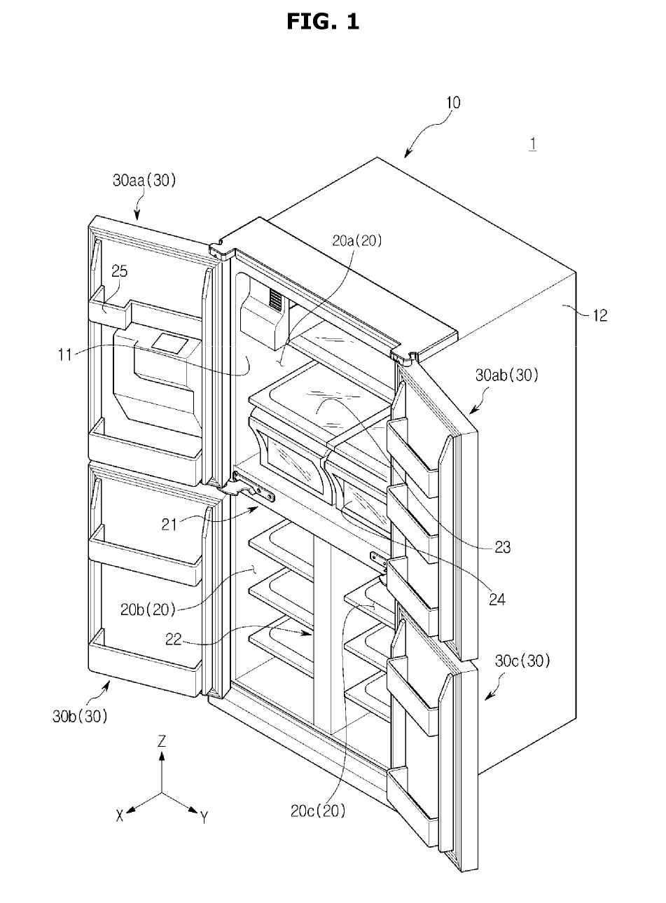

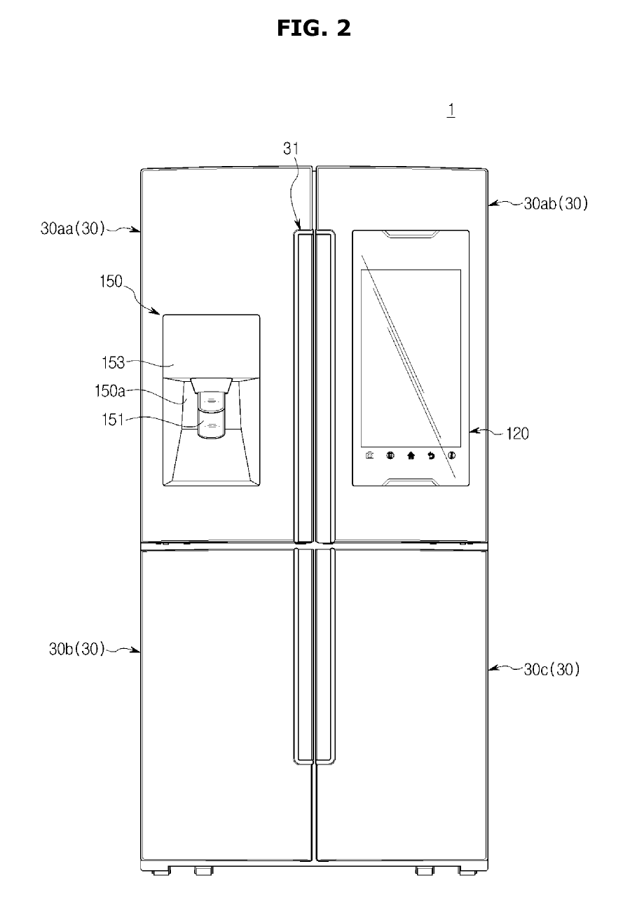

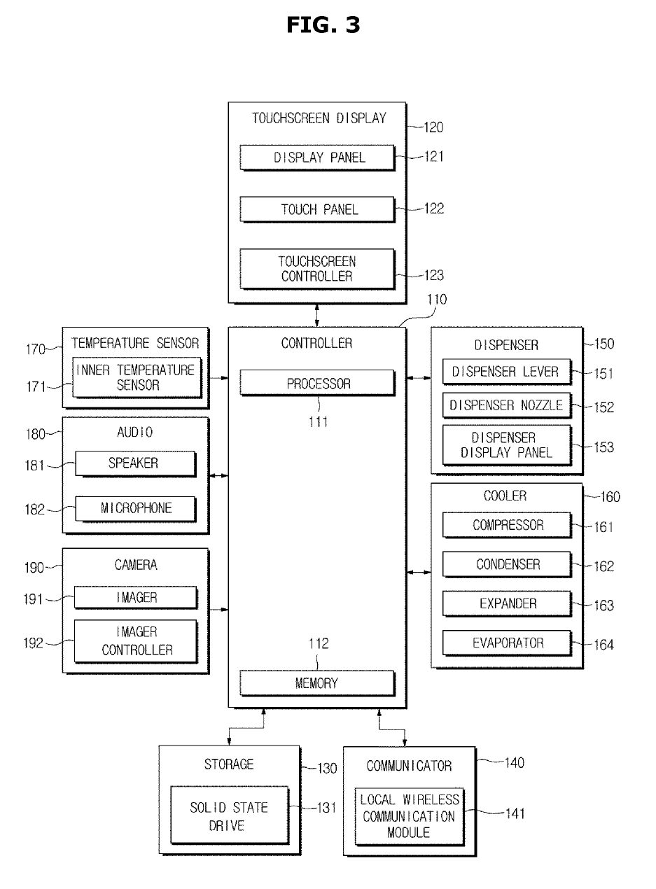

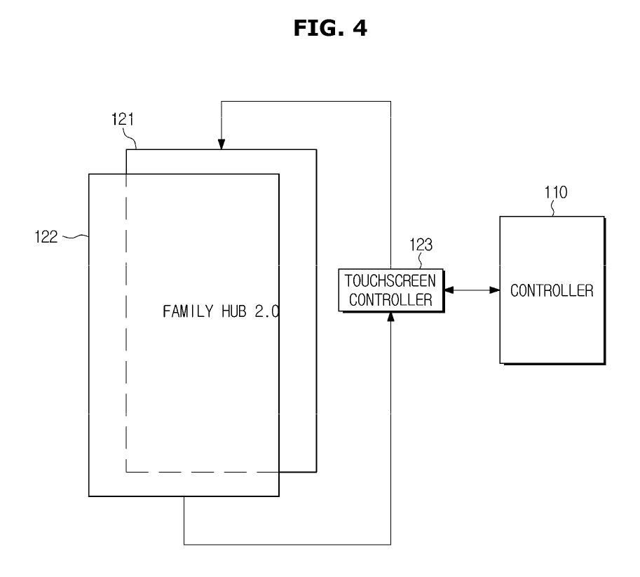

FIG. 1 illustrates an exterior of a refrigerator according to one embodiment. FIG. 2 illustrates a front view of the refrigerator according to one embodiment. FIG. 3 illustrates a configuration of the refrigerator according to one embodiment. FIG. 4 illustrates a touchscreen display included in the refrigerator according to one embodiment.

Referring to FIGS. 1, 2, 3, and 4, a refrigerator 1 may include a main body 10 having an open front surface, a storage compartment 20 formed inside the main body 10 and configured to keep food refrigerated and/or frozen, and a door 30 configured to open and close the open front surface of the main body 10.

The main body 10 may form an exterior of the refrigerator 1. The main body 10 may include an inner case 11 forming the storage compartment 20 and an outer case 12 coupled to an outer side of the inner case 11 to form an exterior thereof. A portion between the inner case 11 and the outer case 12 of the main body 10 may be filled with an insulator (not illustrated) capable of preventing leakage of cold air from the storage compartment 20.

The storage compartment 20 may be partitioned into a plurality of sections by a horizontal partition 21 and a vertical partition 22. For example, as illustrated in FIG. 1, the storage compartment 20 may be partitioned into an upper storage compartment 20a, a lower first storage compartment 20b, and a lower second storage compartment 20c. A shelf 23 on which food may be placed and an airtight container 24 configured to keep food airtight may be disposed in the storage compartment 20.

The storage compartment 20 may be opened and closed by the door 30. For example, as illustrated in FIG. 1, the upper storage compartment 20a may be opened and closed by an upper first door 30aa and an upper second door 30ab, the lower first storage compartment 20b may be opened and closed by a lower first door 30b, and the lower second storage compartment 20c may be opened and closed by a lower second door 30c.

A handle 31 may be disposed at the door 30 for the door 30 to be easily opened and closed. The handle 31 may be longitudinally formed in a vertical direction along a portion between the upper first door 30aa and the upper second door 30ab and a portion between the lower first door 30b and the lower second door 30c. Because of this, when the door 30 is closed, the handle 31 may be seen as being integrally formed with the door 30.

As illustrated in FIG. 3, the refrigerator 1 may include a touchscreen display 120, a storage 130, a communicator 140, a dispenser 150, a cooler 160, a temperature sensor 170, an audio 180, a camera 190, and a controller 110.

The touchscreen display 120 may include a display panel 121 configured to display an image, a touch panel 122 configured to receive a touch input, and a touchscreen controller configured to operate/control the display panel 121 and the touch panel 122.

The display panel 121 may convert image data received from the controller 110 through the touchscreen controller 123 into an optical signal that is visible by a user.

The display panel 121 may be implemented as a cathode ray tube (CRT) display panel, a liquid crystal display (LCD) panel, a light emitting diode (LED) panel, an organic LED (OLED) panel, a plasma display panel (PDP), a field emission display (FED) panel, and the like. However, the display panel 121 is not limited thereto, and the display panel 121 may be implemented as various displays capable of visually displaying an optical image corresponding to image data.

The touch panel 122 may receive a user's touch input on the touch panel 122 and output an electrical signal corresponding to the received touch input to the touchscreen controller 123.

For example, the touch panel 122 may sense a user's touch on the touch panel 122 from a change in an electrical resistance value or a change in capacitance and output an electrical signal corresponding to coordinates of a user's touch point to the touchscreen controller 123. The touchscreen controller 123 may determine the coordinates of the user's touch point on the basis of the electrical signal received from the touch panel 122.

The touch panel 122 may be disposed in front of the display panel 121. In other words, the touch panel 122 may be disposed on a surface on which an image is displayed. As a result, the touch panel 122 may be formed of a transparent material to prevent distortion of an image displayed on the display panel 121.

The touch panel 122 may be implemented as a resistive film type touch panel or a capacitance type touch panel. However, the touch panel 122 is not limited thereto and may be implemented as various touch panels capable of sensing a touch or approach of a user and outputting an electrical signal corresponding to coordinates of a sensed touch point or coordinates of a sensed approach point.

The touchscreen controller 123 may control operations of the display panel 121 and the touch panel 122. For example, as illustrated in FIG. 4, the touchscreen controller 123 may control the touch panel 122 to detect coordinates of the user's touch point and control the display panel 121 to display an optical image corresponding to image data received from the controller 110.

According to an embodiment, the touchscreen controller 123 may determine coordinates of a user's touch point on the basis of an electrical signal output by the touch panel 122 and output the coordinates of the user's touch point to the controller 110. According to an embodiment, the touchscreen controller 123 may transmit an electrical signal output by the touch panel 122 to the controller 110 for the controller 110 to determine coordinates of a user's touch point.

The touchscreen controller 123 may include a memory configured to store a program and data for controlling operations of the display panel 121 and the touch panel 122, and a microprocessor configured to perform a computation for controlling the display panel 121 and the touch panel 122 according to the program and data stored in the memory. The memory and the processor of the touchscreen controller 123 may be implemented as separate chips or a single chip.

In this way, the touchscreen display 120 may receive a touch input from a user and display an image according to the user's touch input. In other words, the touchscreen display 120 may interact with the user.

The touchscreen display 120 may be installed at the door 30 for user convenience. For example, as illustrated in FIG. 2, the touchscreen display 120 may be installed at the upper second door 30ab. Although the touchscreen display 120 installed at the upper second door 30ab will be described below, the installation position of the touchscreen display 120 is not limited to the upper second door 30ab. For example, the touchscreen display 120 may be installed anywhere such as the upper first door 30aa, the lower first door 30b, the lower second door 30c, and the outer case 12 of the main body 10 as long as the touchscreen display 120 is visible by the user.

The touchscreen display 120 may have a wake-up function in which the touchscreen display 120 is automatically activated when a user approaches the touchscreen display 120 within a predetermined range. For example, when the user approaches the touchscreen display 120 within a predetermined range, the touchscreen display 120 may be activated. In other words, the touchscreen display 120 may be turned on. When a predetermined amount of time elapses after the user deviates from the predetermined range, the touchscreen display 120 may be deactivated. In other words, the touchscreen display 120 may be turned off.

The touchscreen display 120 may display various screens or images. The screens or images displayed on the touchscreen display 120 will be described in detail below.

The storage 130 may include a nonvolatile memory configured to store a program or include power so that the program or data stored therein is not lost even when power is cut off. For example, the storage 130 may include a high capacity flash memory, a solid state drive (SSD) 131, or the like.

The storage 130 may store a control program and control data for controlling an operation of the refrigerator 1 and various application programs and application data that perform various functions according to a user's input. For example, the storage 130 may store an operating system (OS) program that manages configurations and resources (software and hardware) included in the refrigerator 1, an album application through which an image is displayed, a memo application through which a memo is stored and displayed, a To-do application through which things to do are recorded, a sketch application through which sketching is possible, a scheduler application through which a schedule is managed, a recipe application through which a recipe of a dish is searched for and displayed, an online shopping application through which a product is purchased online, a shopping list application through which a product to be purchased online is managed, a view-inside application through which food stored in the refrigerator 1 is captured and the captured food is managed, and a morning briefing application through which news, schedules, weathers, and the like are displayed.

The storage 130 may provide a program and data to the controller 110 according to a storage control signal of the controller 110 or store data output from the storage 110.

The communicator 140 may transmit and receive data to and from an external device according to a communication control signal of the controller 110. For example, the communicator 140 may include a local wireless communication module 141.

The local wireless communication module 141 may wirelessly transmit and receive data to and from an external device at a relatively short distance therefrom. For example, the local wireless communication module 141 may communicate with an external device using a communication standard such as wireless fidelity (WiFi), Bluetooth, and ZigBee.

The local wireless communication module 141 may include an antenna configured to transmit a wireless signal to a free space or receive a wireless signal from the free space, a modulator/demodulator configured to modulate data to be transmitted or demodulate a received wireless signal, and the like.

The dispenser 150 may discharge water or ice according to a user's input. In other words, the user may directly discharge water or ice to the outside through the dispenser 150 without opening the door 30.

The dispenser 150 may include a dispenser lever 151 configured to receive a user's discharge command, a dispenser nozzle 152 configured to discharge water or ice, and a dispenser display panel 153 configured to display an operational state of the dispenser 150.

The dispenser 150 may be installed at an outer side of the door 30 or the main body 10. For example, as illustrated in FIG. 2, the dispenser 150 may be installed at the upper first door 30aa. Although the dispenser 150 installed at the upper first door 30aa will be described below, the installation position of the dispenser 150 is not limited to the upper first door 30aa. The dispenser 150 may be installed anywhere such as the upper second door 30ab, the lower first door 30b, the lower second door 30c, and the outer case 12 of the main body 10 as long as the user is able to discharge water or ice through the dispenser 150.

A cavity 150a recessed to form a discharge space of water or ice may be disposed at the door 30, and the dispenser nozzle 152 and the dispenser lever 151 may be disposed in the cavity 150a. Water or ice may be discharged from the dispenser nozzle 152 when the user presses the dispenser lever 151.

The cooler 160 may supply cold air to the storage compartment 20. Specifically, the cooler 160 may use evaporation of a refrigerant to maintain temperature of the storage compartment 20 within a predetermined range.

The cooler 160 may include a compressor 161 configured to compress a gaseous refrigerant, a condenser 162 configured to change a phase of the compressed gaseous refrigerant to a liquid state, an expander 163 configured to decompress the liquid refrigerant, and an evaporator 164 configured to change a phase of the decompressed liquid refrigerant to a gaseous phase.

The cooler 160 may use a phenomenon in which thermal energy is absorbed from surrounding air while the phase of the liquid refrigerant is changed to a gaseous state to cool air in the storage compartment 20.

However, the cooler 160 is not limited to including the compressor 161, the condenser 162, the expander 163, and the evaporator 164.

For example, the cooler 160 may also include a Peltier element using the Peltier effect. The Peltier effect refers to a phenomenon in which, when a current is applied to a contact surface at which two different metals come into contact with each other, an exothermic phenomenon occurs at one metal and an endothermic phenomenon occurs at the other metal. The cooler 160 may user the Peltier element and cool the air in the storage compartment 20.

As another example, the cooler 160 may include a magnetic cooling device using the magneto-caloric effect. The magneto-caloric effect refers to a phenomenon in which a specific material (magneto-caloric material) dissipates heat when the specific material (magneto-caloric material) is magnetized, and the specific material (magneto-caloric material) absorbs heat when the specific material (magneto-caloric material) is demagnetized. The cooler 160 may use the magnetic cooling device to cool air in the storage compartment 20.

The temperature sensor 170 may include inner temperature sensors 171 disposed inside the storage compartment 20 and configured to sense temperature inside the storage compartment 20.

The inner temperature sensors 171 may be respectively installed in a plurality of storage compartments 20a, 20b, and 20c, sense temperatures inside the storage compartments 20a, 20b, and 20c, and output electrical signals corresponding to the sensed temperatures to the controller 110. Each of the inner temperature sensors 171 may include a thermistor whose electrical resistance changes according to temperature.

The audio 180 may include a speaker 181 configured to convert an electrical signal received from the controller 110 into an acoustic signal and output the acoustic signal, and a microphone 182 configured to convert an acoustic signal into an electrical signal and output the electrical signal to the controller 110.

The camera 190 may include an imager 191 configured to capture an image and convert the captured image into an electrical signal, and an imager controller 192 configured to process an electrical signal output by the imager 191 and generate image data.

The imager 191 may include a plurality of photodiodes configured to convert an optical signal into an electrical signal, and the plurality of photodiodes may be two-dimensionally disposed. The imager 191 may include a charge-coupled device (CCD) image sensor or a complementary metal-oxide semiconductor (CMOS) image sensor in which the plurality of photodiodes are two-dimensionally disposed.

The imager controller 192 may control an operation of the imager 191 and generate image data from an electrical signal output by the imager 191. The imager controller 192 may output the image data to the controller 110.

The camera 190 may be installed inside the storage compartment 20 and acquire an image of food stored in the storage compartment 20. The camera 190 may output the image of the food to the controller 110.

The controller 110 may include a memory 112 configured to store a program and data for controlling an operation of the refrigerator 1, and a processor 111 configured to generate a control signal for controlling the operation of the refrigerator 1 according to the program and data stored in the memory 112. The processor 111 and the memory 112 may be implemented as separate chips or a single chip.

The memory 112 may temporarily store a user's touch input data input through the touchscreen display 120, storage data stored in the storage 130, communication data received through the communicator 140, and/or temperature data sensed through the temperature sensor 170. For example, the memory 112 may store a screen and/or an image to be displayed on the touchscreen display 120 and may store coordinates of a user's touch input through the touchscreen display 120 and a control command corresponding to the user's touch input.

The memory 112 may include a volatile memory such as a static random access memory (S-RAM), a dynamic RAM (D-RAM), and the like configured to temporarily store data. Also, the memory 112 may include a nonvolatile memory such as a read only memory (ROM), an erasable programmable ROM (EPROM), an electrically EPROM (EEPROM), and the like configured to store data for a long period.

The processor 111 may include various types of logic circuits and arithmetic circuits, process data according to a program provided from the memory 112, and generate a control signal according to a result of the processing.

For example, the processor 111 may process a touch input that is input through the touchscreen display 120 and determine a user's control command according to coordinates of the touch input. Also, the processor 111 may control the communicator 140 to acquire information corresponding to the user's control command and control the touchscreen display 120 to display a screen and/or an image corresponding to the user's control command.

The processor 111 may process input data that is input through the touchscreen display 120 and transmit the input data to an external device through the communicator 140. Also, the processor 111 may process communication data received through the communicator 140 and display an image indicated by the communication data on the touchscreen display 120.

In this way, the controller 110 may control an operation of the refrigerator 1 according to a user's input received through the touchscreen display 120 and/or a program and data stored in the storage 130.

Although the touchscreen display 120, the storage 130, the communicator 140, the dispenser 150, the cooler 160, the temperature sensor 170, the audio 180, and the controller 110 included in the refrigerator 1 have been described above, a new configuration may be added or some of the above configurations may be omitted as necessary.

An operation of the refrigerator 1 which will be described below may be viewed as being performed by control of the controller 110.

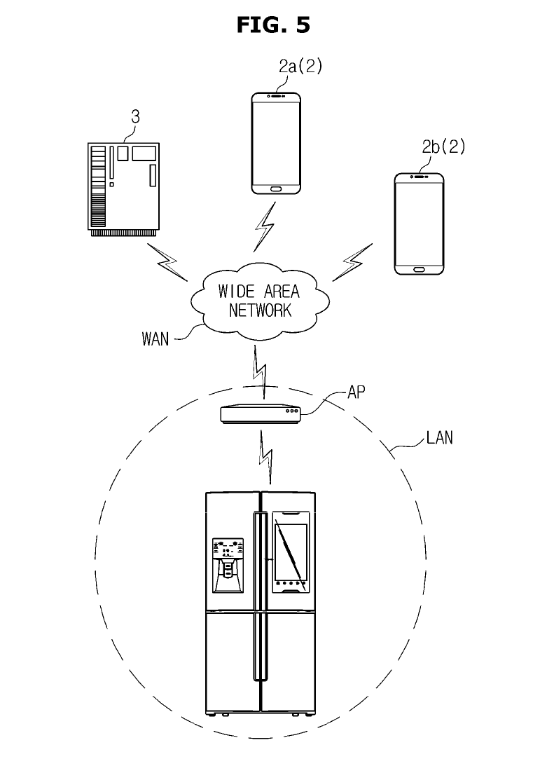

FIG. 5 illustrates an example in which the refrigerator according to one embodiment communicates with external devices.

The refrigerator 1 may communicate with various external electronic devices through the communicator 140.

For example, as illustrated in FIG. 5, the refrigerator 1 may connect to an access point (AP) through the communicator 140. Specifically, the refrigerator 1 may connect to an AP using a wireless communication standard such as Wi-Fi™ (IEEE 802.11), Bluetooth™ (IEEE 802.15.1), ZigBee (IEEE 802.15.4), or the like.

The AP may be referred to by various terms such as “hub,” “router,” “switch,” and “gateway” and may be connected to a wide area network (WAN) such as the Internet.

Various home appliances, other than the refrigerator 1, such as an air conditioner, a washing machine, an electric oven, a microwave oven, a robot cleaner, a security camera, an electric lamp, and a television may also be connected to the AP. The home appliances connected to the AP may form a local area network (LAN).

The AP may connect the LAN formed by the home appliances connected to the AP to the WAN such as the Internet.

A service server 3 configured to provide a predetermined service to the refrigerator 1 and user devices 2 (2a and 2b) may be connected to the WAN.

The service server 3 may provide various services to the refrigerator 1. For example, the service server 3 may manage account information of a user of the refrigerator 1 and store a picture, a video, a memo, a schedule, things to do, a sketch, and the like input by the user of the refrigerator 1. The service server 3 may search for a recipe of a dish in response to a request from the refrigerator 1, provide the recipe to the refrigerator 1, and transmit a shopping list of items to be purchased online to an online shopping mall server.

The service server 3 may transmit a picture, a video, a memo, a schedule, things to do, a sketch, a recipe, a shopping list of items, and the like received from the refrigerator 1 to the user devices 2 (2a and 2b).

The user devices 2 (2a and 2b) may connect to the WAN through a mobile communication service provided by a mobile carrier or connect to the WAN through the AP.

The user devices 2 (2a and 2b) may connect wirelessly or via a wire to the WAN and communicate with other devices such as the refrigerator 1. The user devices 2 (2a and 2b) may be portable devices that may be carried by a user or fixed devices that are difficult to carry. For example, the user devices 2 (2a and 2b) may be referred to by various terms such as mobile phones, cellular phones, smartphones, personal communication services (PCS), personal digital assistants (PDAs), computers, notebooks, personal computers (PCs), laptops, and desktops.

Hereinafter, a configuration and an operation of the user devices 2 (2a and 2b) will be described.

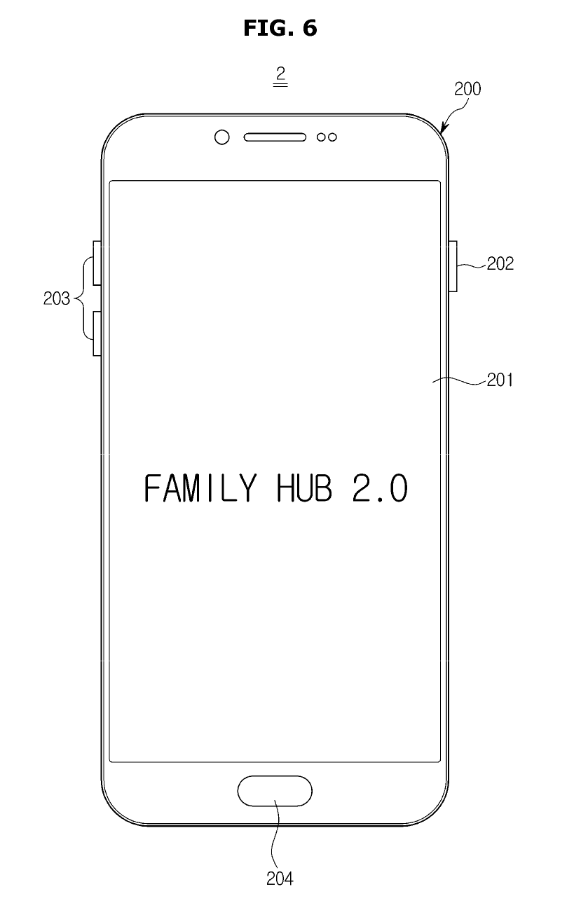

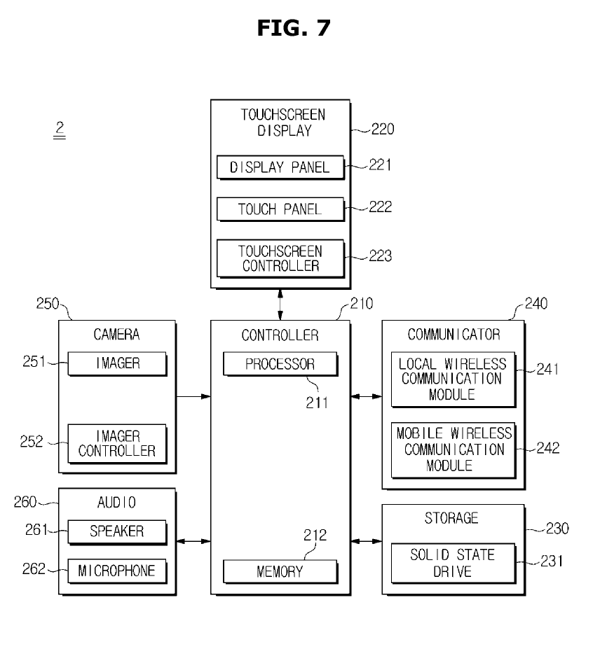

FIG. 6 illustrates an exterior of a user device according to one embodiment. FIG. 7 illustrates a configuration of the user device according to one embodiment.

The user device 2 may include a box-shaped main body 200, a screen 201 disposed at a front surface of the main body 200, and input buttons 202, 203, and 204 disposed at the front surface or side surfaces of the main body 200.

The main body 200 may form an exterior of the user device 2 and accommodate and protect various configurations included in the user device 2 which will be described below.

The screen 201 may receive a user's input and display an image according to the user's input.

The input buttons 202, 203, and 204 may receive a predetermined command from a user. For example, the input buttons 202, 203, and 204 may include a power button 202 for turning the user device 2 on and off, a volume control button 203 for controlling a volume of sound being output by the user device 2, and a home button 204 for changing an image displayed on the screen 201 of the user device 2 to a home screen.

The user device 2 may include a touchscreen display 220, a storage 230, a communicator 240, a camera 250, an audio 260, and a controller 210.

The touchscreen display 220 may form the screen 201 of the main body 200. The touchscreen display 220 may include a display panel 221 configured to display an image, a touch panel 222 configured to receive a touch input, and a touchscreen controller 223 configured to operate/control the display panel 221 and the touch panel 222.

The display panel 221, the touch panel 222, and the touchscreen controller 223 may be different from the display panel 121, the touch panel 122, and the touchscreen controller 123, described with reference to FIGS. 3 and 4, in terms of sizes and installation positions but may have the same functions as the display panel 121, the touch panel 122, and the touchscreen controller 123.

The storage 230 may include a nonvolatile memory configured to store a program or include power so that the program or data stored therein is not lost even when power is cut off. For example, the storage 230 may include a high capacity flash memory, an SSD 231, or the like.

The storage 230 may store a control program and control data for controlling an operation of the user device 2 and various application programs and application data that perform various functions according to a user's input. For example, the storage 230 may store an OS program, an album application, a memo application, a To-do application, a sketch application, a scheduler application, an online shopping application, a shopping list application, a view-inside application, and the like.

The storage 230 may provide a program and data to the controller 210 according to a storage control signal of the controller 210 or store data output from the controller 210.

The communicator 240 may transmit and receive data to and from an external device according to communication control of the controller 210. For example, the communicator 240 may include a local wireless communication module 241 and a mobile wireless communication module 242 configured to wirelessly transmit communication data to an external device and wirelessly receive communication data from the external device.

The local wireless communication module 241 may wirelessly transmit and receive data to and from an external device at a relatively short distance therefrom. For example, the local wireless communication module 241 may communicate with an external device using a communication standard such as WiFi, Bluetooth, and ZigBee.

The mobile wireless communication module 242 may wirelessly transmit and receive data to and from a base station and connect to the WAN through the base station or communicate with an external device through the base station. For example, the mobile wireless communication module 242 may communicate using a communication standard such as time division multiple access (TDMA), code DMA (CDMA), wide CDMA (WCDMA), CDMA2000, a wireless broadband (Wibro), World Interoperability for Microwave Access (WiMAX), long term evolution (LTE), and/or wireless broadband evolution.

Each of the local area wireless communication module 241 and the mobile wireless communication module 242 may include an antenna configured to transmit a wireless signal to a free space or receive a wireless signal from the free space, a modulator/demodulator configured to modulate data to be transmitted or demodulate a received wireless signal, and the like.

The camera 250 may include an imager 251 configured to capture an image and convert the captured image into an electrical signal, and an imager controller 252 configured to process an electrical signal output by the imager 251 and generate image data.

The imager 251 may include a plurality of photodiodes configured to convert an optical signal into an electrical signal, and the plurality of photodiodes may be two-dimensionally disposed.

The imager controller 252 may control an operation of the imager 251 and generate image data from an electrical signal output by the imager 251. The imager controller 252 may output the image data to the controller 210.

The camera 250 may be installed outside the main body 201, acquire an image of an external subject to be captured, and output the acquired image to the controller 210.

The audio 260 may include a speaker 261 configured to convert an electrical signal received from the controller 210 into an acoustic signal and output the acoustic signal, and a microphone 262 configured to convert an acoustic signal into an electrical signal and output the electrical signal to the controller 210.

The controller 210 may include a memory 212 configured to store a program and data for controlling an operation of the user device 2, and a processor 211 configured to generate a control signal for controlling the operation of the refrigerator 1 according to the program and data stored in the memory 212. The processor 211 and the memory 212 may be implemented as separate chips or a single chip.

The memory 212 may temporarily store a user's touch input data input through the touchscreen display 220, storage data stored in the storage 230, communication data received through the communicator 240, and/or image data acquired through the camera 250.

The memory 212 may include a volatile memory such as an S-RAM, a D-RAM, and the like configured to temporarily store data and a nonvolatile memory such as a ROM, an EPROM, an EEPROM, and the like configured to store data for a long period.

The processor 211 may include various types of logic circuits and arithmetic circuits, process data according to a program provided from the memory 212, and generate a control signal according to a result of the processing.

For example, the processor 211 may process a touch input that is input through the touchscreen display 220 and control the touchscreen display 220 to display a screen and/or an image in response to the touch input. The processor 211 may also transmit data to an external device through the communicator 240 or receive data from the external device in response to the touch input.

In this way, the controller 210 may control an operation of the user device 2 according to a user's input received through the touchscreen display 220 and/or a program and data stored in the storage 230.

The operation of the user device 2, which will be described below, may be viewed as being performed by control of the controller 210.

Although the touchscreen display 220, the storage 230, the communicator 240, the camera 250, the audio 260, and the controller 210 included in the user device 2 have been described above, a new configuration may be added or some of the above configurations may be omitted as necessary.

Hereinafter, operations of the refrigerator 1 and the user device 2 will be described.

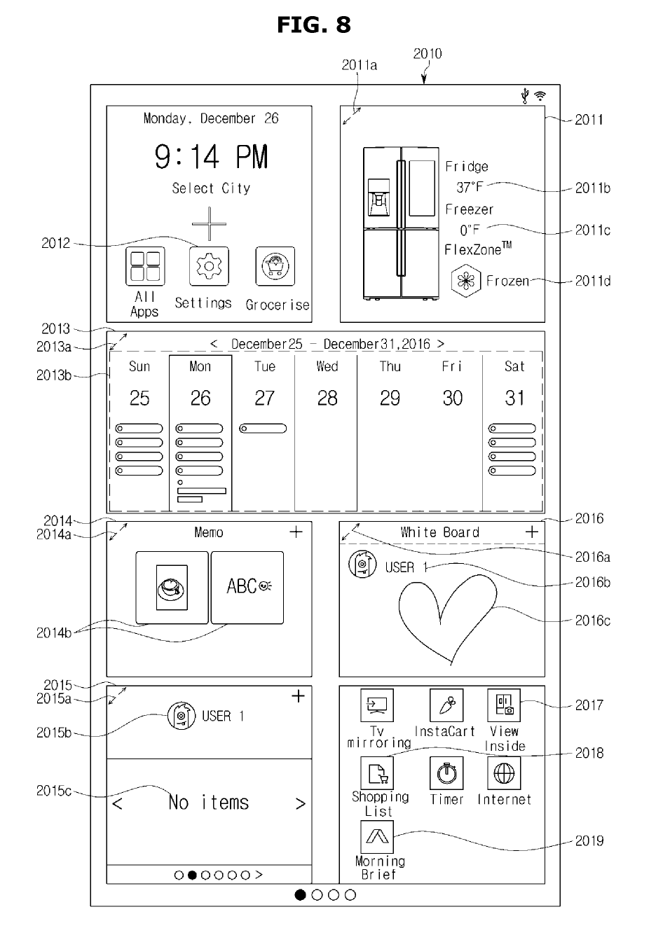

FIG. 8 illustrates a home screen displayed on the touchscreen display included in the refrigerator according to one embodiment.

When the touchscreen display 120 of the refrigerator 1 is activated, the controller 110 may display a home screen on the touchscreen display 120. Various graphic user interface (GUI) elements may be displayed on the home screen. The GUI elements may include a widget capable of directly interacting with a user on a first home screen 2010 and an icon for executing an application stored in the storage 130.

For example, the refrigerator 1 may display the first home screen 2010 illustrated in FIG. 8 on the touchscreen display 120.

A temperature setting GUI element 2011 may be displayed on the first home screen 2010. The temperature setting GUI element 2011 may include a run button 2011a for running a temperature setting application through which temperature of the upper storage compartment 20a (see FIG. 1), temperature of the lower first storage compartment 20b (see FIG. 1), and a function (refrigerating or freezing) of the lower second storage compartment 20c (see FIG. 1) are set, a refrigerating temperature region 2011b configured to display the temperature of the upper storage compartment 20a (see FIG. 1), a freezing temperature region 2011c configured to display the temperature of the lower first storage compartment 20b (see FIG. 1), and refrigerating/freezing setting region 2011d configured to display a function (refrigerating or freezing) of the lower second storage compartment 20c (see FIG. 1).

A refrigerator setting GUI element 2012 may be displayed on the first home screen 2010. In response to a touch input to the refrigerating setting GUI element 2012, a refrigerator setting application for controlling operations of the touchscreen display 120, the dispenser 150, the cooler 160, the audio 180, and the like may be run. Particularly, the user may add or delete a user using the refrigerator 1 by using the refrigerator setting application.

A scheduler GUI element 2013 may be displayed on the first home screen 2010. The scheduler GUI element 2013 may include a run button 2013a for running a scheduler application that manages a schedule and a schedule region 2013b configured to display schedules of users according to date and time.

A memo GUI element 2014 may be displayed on the first home screen 2010. The memo GUI element 2014 may include a run button 2014a for running a memo application through which a memo is stored and displayed and a memo region 2014b configured to display a memo input by the users. Particularly, a plurality of memos input by different users may be separately displayed in the memo region 2014b.

A To-do GUI element 2015 may be displayed on the first home screen 2010. The To-do GUI element 2015 may include a run button 2015a for running a To-do application through which things to do are recorded, a performer display region 2015b configured to display a performer of things to do, and a things-to-do display region 2015c configured to display things to do input by the users. Particularly, things to do of different users may be separately displayed in the things-to-do display region 2015c.

A sketch GUI element 2016 may be displayed on the first home screen 2010. The sketch GUI element 2016 may include a run button 2016a for running a sketch application through which sketching is possible, a writer display region 2016b configured to display a writer of a sketch, and a sketch display region 2016c configured to display a sketch of a user. Particularly, sketches of different users may be separately displayed in the sketch display region 2016c.

A view-inside GUI element 2017 may be displayed on the first home screen 2010. In response to a touch input to the view-inside GUI element 2017, a view-inside application through which food stored in the refrigerator 1 is captured and displayed may be run.

A shopping list GUI element 2018 may be displayed on the first home screen 2010. In response to a touch input to the shopping list GUI element 2018, a shopping list application though which products to be purchased online are managed may be run.

A morning briefing GUI element 2019 may be displayed on the first home screen 2010. In response to a touch input to the morning briefing GUI element 2019, a morning briefing application for morning briefing may be run.

As described above, GUI elements for displaying major information related to an operation of the refrigerator 1 or running various applications may be displayed on the home screen of the refrigerator 1.

However, the first home screen 2010 illustrated in FIG. 8 is merely an example of a home screen, and the refrigerator 1 may display various forms of home screens according to the user's settings and the like. The GUI elements displayed on the home screen are also not limited to those illustrated in FIG. 8.

Hereinafter, operations of the refrigerator 1 performed by the GUI elements on the home screen will be described.

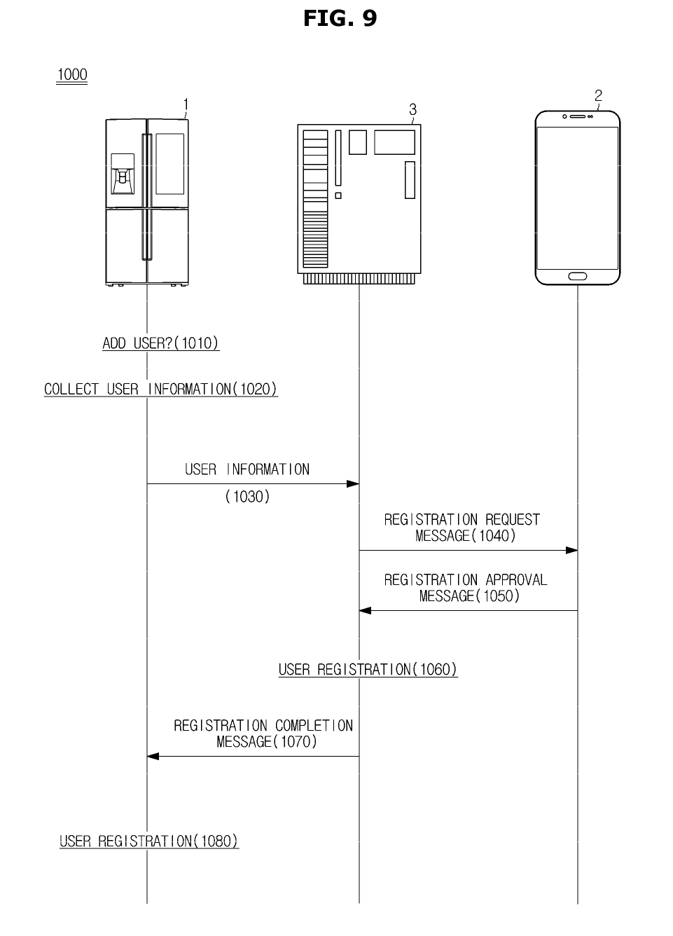

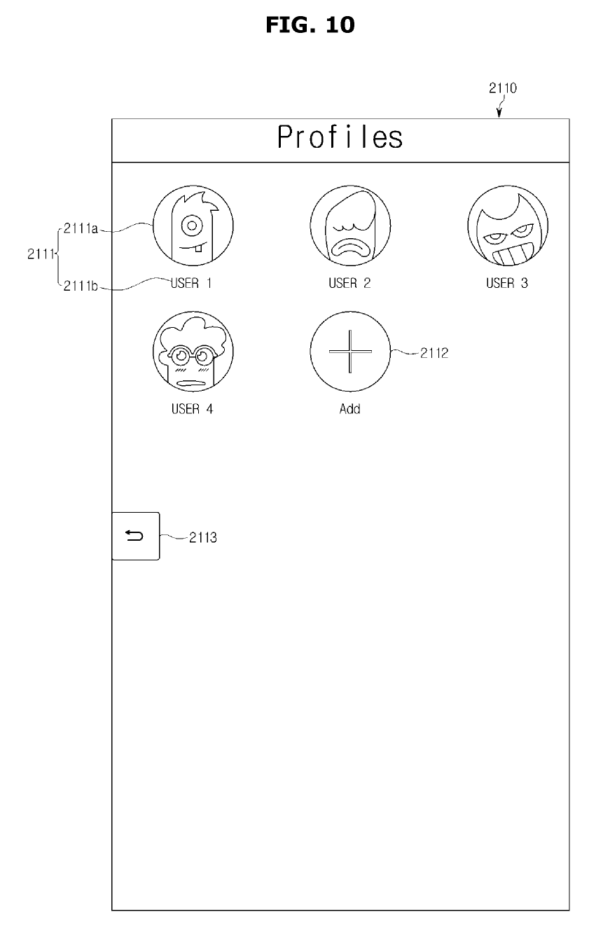

FIG. 9 illustrates a method of adding a user to the refrigerator according to one embodiment. FIGS. 10, 11, and 12 illustrate screens for adding a user by using the method of adding a user illustrated in FIG. 9.

The refrigerator 1 may be used by a plurality of users. For example, when the refrigerator 1 is installed at home, all family members may use the refrigerator 1. Consequently, several people (e.g., family members) may be registered to the refrigerator 1 as users.

According to an embodiment, all of the users may belong to the same class or the users may be classified into different classes. For example, the users may be classified as a main user and sub-users. The main user may represent the users of the refrigerator 1 and may use most of the functions of the refrigerator 1. The main user's account may be registered to the service server 3 to register the refrigerator 1 to the service server 3. The sub-users may user various functions of the refrigerator 1 together with the main user. An account of each of the sub-users may be registered to the service server 3 as a sub-user.

A user registration method (1000) in which the refrigerator 1 registers a new user will be described with reference to FIGS. 9, 10, 11, and 12.

The refrigerator 1 determines whether to add a user (1010).

The refrigerator 1 may determine whether to add a user according to a user's touch input through the touchscreen display 120.

Users (a main user and/or sub-users) may run the refrigerator setting application to add a new user (sub-user). For example, the user may input a touch input to the refrigerator setting GUI element 2012 displayed on the first home screen 2010.

Through the refrigerator setting application, the user may select a user adding menu from a screen displayed on the touchscreen display 120. When the user adding menu is selected, the refrigerator 1 may determine to add a user.

When adding a user, the refrigerator 1 collects user information of the new user (1020).

The refrigerator 1 may collect the user information of the new user through the touchscreen display 120.

For example, the refrigerator 1 may display a user information screen 2110 as illustrated in FIG. 10.

The user information screen 2110 may display pieces of information on a plurality of pre-registered users USER1, USER2, USER3, and USER4. The user information screen 2110 may include pieces of identification information 2111 of the plurality of pre-registered users USER1, USER2, USER3, and USER4, a user registration button 2112 for registering a new user, and a back button 2113 for returning to a previous screen.

The pieces of identification information 2111 of the plurality of users USER1 to USER 4 may include an identification image 2111a showing each of the plurality of users USER1 to USER4 and an identification text 2111b (a name, a nickname, an abbreviated name, etc.) indicating each of the plurality of users.

The identification image 2111a and the identification text 2111b may indicate a corresponding user. The users of the refrigerator 1 may be differentiated from other users through the identification images 2111a and the identification texts 2111b.

When a touch input is made to the user registration button 2112, the refrigerator 1 may display the user registration screen for registering a new user on the touchscreen display 120.

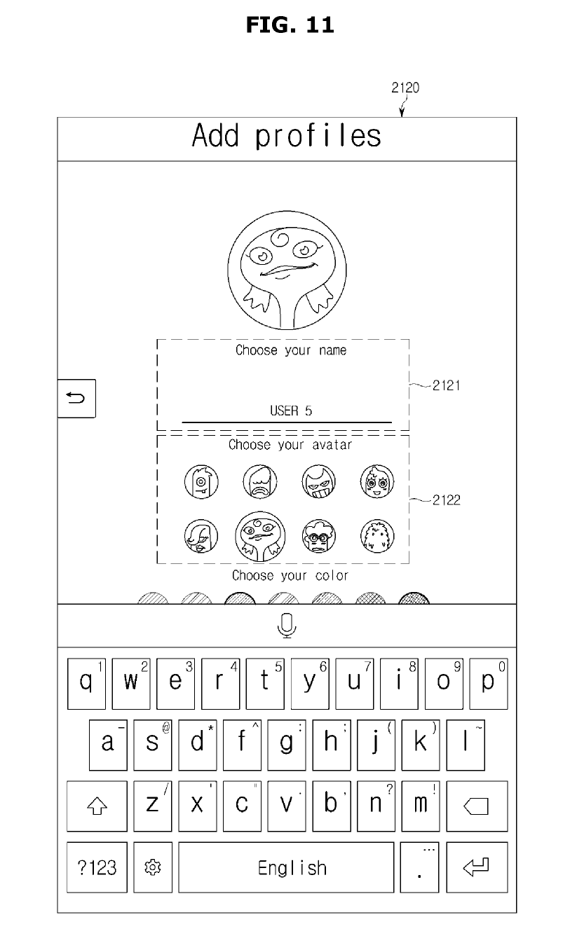

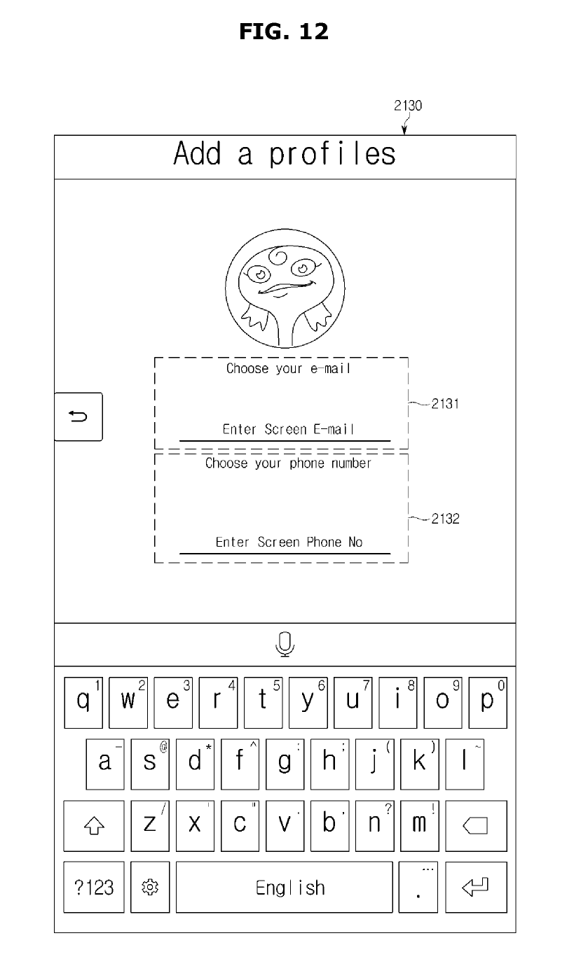

For example, the refrigerator 1 may display a first user registration screen 2120 and a second user registration screen 2130 respectively illustrated in FIGS. 11 and 12.

The identification text and the identification image for identifying a user may be input to the first user registration screen 2120. The first user registration screen 2120 may include an identification text input region 2121 for inputting a new user's identification text and an identification image selection region 2122 for selecting the new user's identification image. The user may input a name, a nickname, an abbreviated name, or the like indicating a new user in the identification text input region 2121, and any one of a plurality of images 2122a displayed in the identification image selection region 2122 may be selected.

Pieces of contact information for contacting a new user may be input to the second user registration screen 2130. The second user registration screen 2130 may include a mail address input region 2131 for inputting the new user's electronic mail address and a phone number input region 2132 for inputting the new user's phone number. The mail address input to the mail address input region 2131 may be used as an account identification (ID) that represents the new user. Also, the phone number input to the phone number input region 2132 may be used to identify a user device (e.g., a cellular phone) of the new user.

When the new user previously generated a user account using a mail address and a phone number in the service server 3, the user device 2 of the new user and the refrigerator 1 may be linked to each other and be operated. For example, the new user may change a memo, things to do, a sketch, a schedule, and the like of the new user by using the refrigerator 1 as well as the user device 2.

A mail address and/or a phone number input through the second user registration screen 2130 are not essentially required. For example, when the new user is a child, the new user may not have a mail address and/or a phone number, and a mail address and/or a phone number may not be input.

The refrigerator 1 which collected the user information of the user transmits the user information to the service server 3 (1030).

The refrigerator 1 may transmit user information including an identification image, an identification text, a mail address and/or a phone number of the user to the service server 3 through the communicator 140.

The service server 3 which received the user information of the user transmits a registration request message for checking user registration to the user device 2 of the user (1040).

To check the user information received from the refrigerator 1 and prevent the user account from being stolen, the service server 3 may transmit the registration request message for checking user registration to the user device 2.

For example, the service server 3 may transmit a text message (a short message service (SMS) message) to the user device 2 on the basis of the phone number included in the user information. The text message may display a message indicating that a user registration is requested through the refrigerator 1 or may request for an input of an authentication code for authenticating a user.

As another example, the service server 3 may transmit an electronic mail to the user device 2 on the basis of the mail address included in the user information. The electronic mail may display a message indicating that a user registration is requested through the refrigerator 1 or may request for an input of an authentication code for authenticating a user.

The user may check the user registration message (a text message and/or an electronic mail) received by the user device 2 and input an authentication code. The authentication code may be a preset password of the user account or a one-time password (OTP) arbitrarily generated by the service server 3 and transmitted to the user device 2 and the refrigerator 1.

The user device 2 transmits a registration approval message that approves of the registration of the new account to the refrigerator 1 to the service server 3 (1050).

When the authentication code is input, the user device 2 may transmit the authentication code to the service server 3, and the service server 3 may determine whether the authentication code input by the user matches a previously stored/generated authentication code. When the authentication code input by the user matches the previously stored/generated authentication code, user authentication is completed.

When the user authentication using the authentication code is completed, the user device 2 may transmit the registration approval message that approves of the registration of the new account to the refrigerator 1 to the service server 3 through the communicator 240.

The above-described user authentication operations (1040 and 1050) by the user device 2 may be selective operations. For example, although the above user authentication operations (1040 and 1050) are performed when the user inputs a mail address and a phone number to the refrigerator 1, the above user authentication operations (1040 and 1050) may not be performed when the user does not input a mail address and a phone number to the refrigerator 1.

The service server 3 which received the registration approval message registers a new user (1060).

The service server 3 may register the new user on the basis of the user information received from the refrigerator 1. For example, the service server 3 may additionally store user information of the new user in a list of users of the refrigerator 1.

When the user does not input a mail address and a phone number to the refrigerator 1, the service server 3 may register the new user in response to reception of the user information from the refrigerator 1.

Then, the service server 3 transmits a registration completion message indicating that the user registration is completed to the refrigerator 1 (1070).

In response to reception of the registration completion message from the service server 3, the refrigerator 1 registers the new user (1080).

The refrigerator 1 may register the new user on the basis of the user information input through the touchscreen display 120. For example, the refrigerator 1 may additionally store the user information of the new user in the list of users.

As described above, the refrigerator 1 may collect user information of a new user and register the new user as the user of the refrigerator 1 on the basis of the collected user information. Specifically, the refrigerator 1 may store the user information of the new user in the list of users.

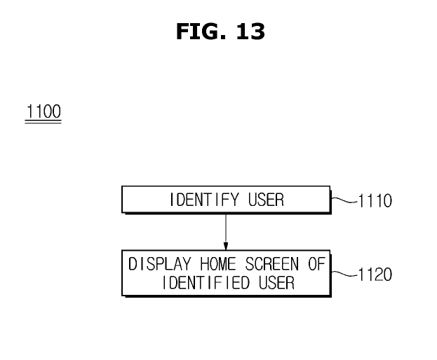

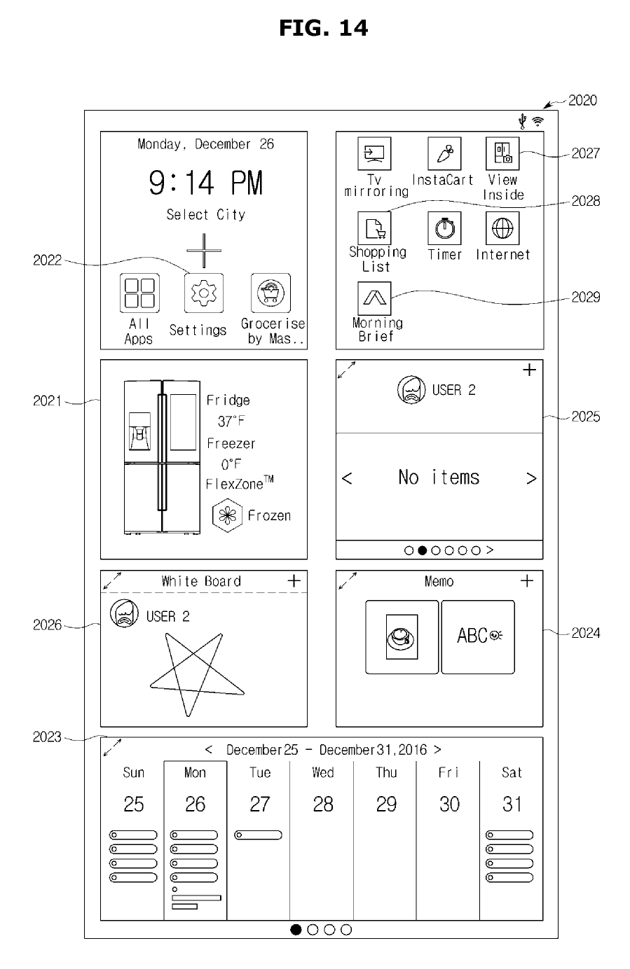

FIG. 13 illustrates a method of displaying another screen with respect to another user by the refrigerator according to one embodiment. FIG. 14 illustrates another home screen displayed on the touchscreen display included in the refrigerator according to one embodiment.

As described above, the refrigerator 1 may be used by a plurality of users and register the plurality of users.

Further, the refrigerator 1 may display a different screen for each of the plurality of users. For example, a home screen displayed for a first user and a home screen displayed for a second user may be different from each other.

A method in which the refrigerator 1 displays a different screen for a different user (1100) will be described with reference to FIGS. 13 and 14.

The refrigerator 1 identifies a user (1110).

The refrigerator 1 may identify a user who is currently using the refrigerator 1. For example, when the user approaches the refrigerator 1, the refrigerator 1 may distinguish the user approaching the refrigerator 1 from a plurality of registered users on the basis of the user's voice, shape, motion, and the like.

The refrigerator 1 may identify the user approaching the refrigerator 1 by using various methods.

For example, the refrigerator 1 may identify a current user of the refrigerator 1 by using voice recognition or speaker recognition. The voice recognition or speaker recognition refers to identifying a user on the basis of features of an individual's voice.

The refrigerator 1 may analyze a spectrum of the user's voice during registration of the user and store the spectrum information. Specifically, the refrigerator 1 may acquire the user's voice using the audio 180 during the registration of the user and extract reference spectrum information of the user's voice. The spectrum information of the voice may indicate a magnitude of a signal according to a frequency of the voice. The refrigerator 1 may store the reference spectrum information of the user's voice together with the user's identification name, identification image, mail address, and/or phone number.

After the user is registered, the refrigerator 1 may acquire the user's voice from the surrounding using the audio 180, extract spectrum information from the acquired voice, and compare the extracted spectrum information of the voice with a plurality of pieces of pre-stored reference spectrum information. When a piece of reference spectrum information matching the extracted spectrum information of the voice is found, the refrigerator 1 may determine the user having the found reference spectrum information as the current user. For example, when the extracted spectrum information of the voice matches reference spectrum information of the first user USER1, the refrigerator 1 may determine the first user USER1 as the current user.

As another example, the refrigerator 1 may identify the current user of the refrigerator 1 using facial recognition. Facial recognition refers to identifying a user on the basis of an individual's facial features.

For facial recognition, the refrigerator 1 may further include a camera (not illustrated). The refrigerator 1 may capture a user's face during registration of the user, analyze a facial image, and store reference feature information. The facial feature information may include positions of the eyes, the nose, the mouth, and the like and/or distances between the eyes, the nose, and the mouth. The refrigerator 1 may store the reference facial feature information together with the user's identification name, identification image, mail address, and/or phone number.

After the user is registered, the refrigerator 1 may capture the user's face placed in front of the refrigerator 1 using the camera and extract facial feature information from the captured facial image. The refrigerator 1 may compare the extracted facial feature information with a plurality of pieces of previously stored reference feature information and determine a user having reference feature information that matches the extracted facial feature information as the current user.

As another example, the refrigerator 1 may identify the current user of the refrigerator 1 using fingerprint recognition, iris recognition, and/or vein recognition. Fingerprint recognition refers to identifying a user on the basis of the shape of a fingerprint formed at an individual's finger or palm, and iris recognition refers to identifying a user on the basis of the shape of wrinkles formed at an individual's iris. Vein recognition refers to identifying a user on the basis of formation of a vein in the back of an individual's hand or palm.

For fingerprint recognition, iris recognition, and vein recognition, the refrigerator 1 may further include a scanner (not illustrated) using infrared rays. The refrigerator 1 may acquire a fingerprint image, an iris image, and/or a vein image of the user during registration of the user and extract reference feature information from the fingerprint image, iris image, and/or vein image. Feature information of a fingerprint, an iris, and/or a vein may include whether the fingerprint, the iris, and/or the vein have distinguishing shapes and positions thereof.

After the user is registered, the refrigerator 1 may acquire the user's fingerprint image, iris image, and/or vein image using the scanner and extract feature information of the fingerprint, the iris, and/or the vein. The refrigerator 1 may compare the extracted feature information of the iris and/or vein with pre-stored reference feature information and determine a user having reference feature information matching the extracted feature information of the iris and/or vein as the current user of the refrigerator 1.

Then, the refrigerator 1 displays a home screen of the identified user on the touchscreen display 120 (1120).

Each of the plurality of users may set his or her home screen, and, after a user is identified, the refrigerator 1 may display a home screen of the identified user.

For example, the first user USER1 may set the above-described first home screen 2010 illustrated in FIG. 8 as his or her home screen. When the first user USER1 is determined as the current user, the refrigerator 1 may display the first home screen 2010 illustrated in FIG. 8 on the touchscreen display 120.

The second user USER2 may set a second home screen 2020 illustrated in FIG. 14 as his or her home screen. When the second user USER 2 is determined as the current user, the refrigerator 1 may display the second home screen 2020 on the touchscreen display 120.

Although the second home screen 2020 may include a temperature setting GUI element 2021, a refrigerator setting GUI element 2022, a scheduler GUI element 2023, a memo GUI element 2024, a To-do GUI element 2025, a sketch GUI element 2026, a view-inside GUI element 2027, a shopping list GUI element 2028, and a morning briefing GUI element 2029, the arrangement of the GUI elements 2021 to 2029 of the second home screen 2020 may be different from that of the GUI elements 2100 to 2019 of the first home screen 2020.

In other words, the refrigerator 1 may display the first home screen 2010 for the first user USER1 and display the second home screen 2020, different from the first home screen 2010, for the second use USER2, different from the first user USER1.

As described above, the refrigerator 1 may identify the current user and display a different home screen for a different user.

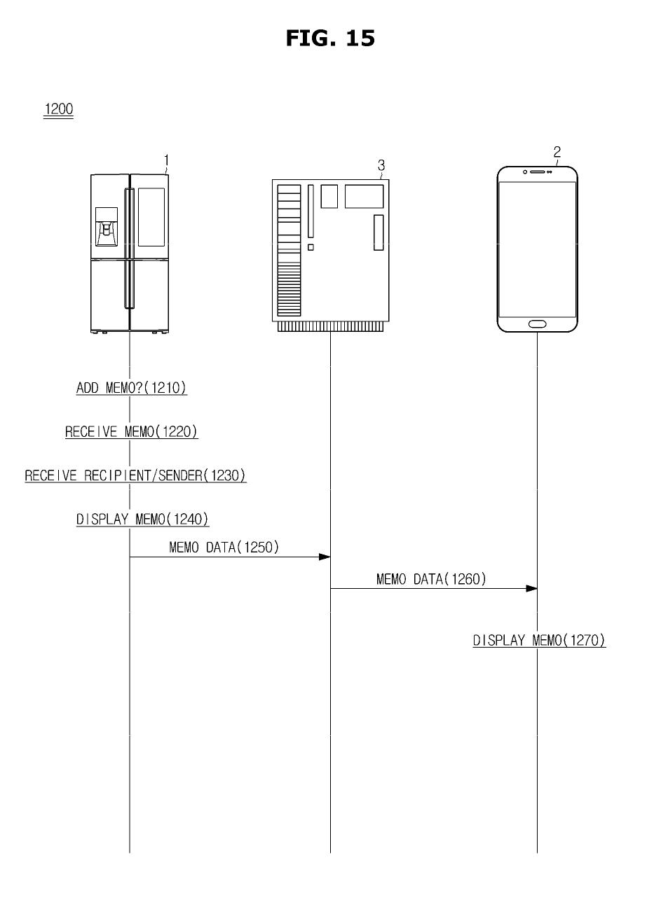

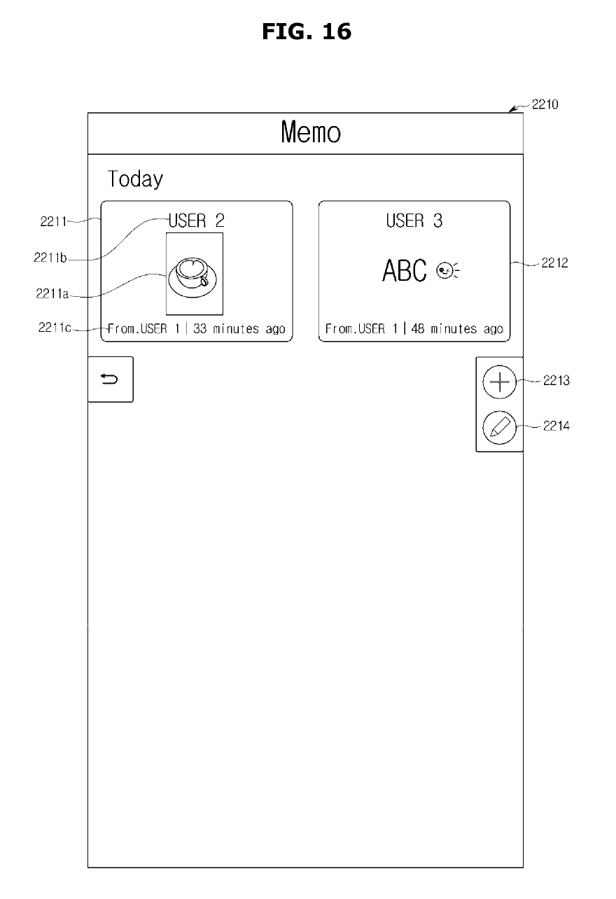

FIG. 15 illustrates a method of generating and displaying a memo by the refrigerator according to one embodiment. FIGS. 16, 17, 18, and 19 illustrate examples of screens for generating and displaying a memo according to the method of generating and displaying a memo illustrated in FIG. 15.

The users may input a memo using the memo application of the refrigerator 1, and the refrigerator 1 may display the memo input by the users.

A method of generating/displaying a memo (1200) in which the refrigerator 1 generates and displays a memo will be described with reference to FIGS. 15, 16, 17, 18, and 19.

The refrigerator 1 determines whether to add a memo (1210).

The refrigerator 1 may determine whether to add a memo according to the user's touch input through the touchscreen display 120. The users may run the memo application to add a memo. For example, the user may input a touch input for the memo GUI elements 2014 and 2024 displayed on the home screens 2010 and 2020. When the touch inputs for the memo GUI elements 2014 and 2024 are made, the refrigerator 1 may determine to add a memo.

When adding a memo, the refrigerator 1 receives a new memo (1220) from a user and receives a recipient and a sender of the memo (1230) from the user.

The refrigerator 1 may receive a new memo from a user via the touchscreen display 120. The user may generate a memo and transmit the memo to a specific user. For example, the first user USER1 may generate a memo and transmit the memo to the fourth user USER4.

The refrigerator 1 may display a memo display screen 2210 as illustrated in FIG. 16. A first memo 2211 and a second memo 2212 input by the users may be displayed on the memo display screen 2210. Each of the memos 2211 and 2212 may include content 2211a of the memo, a recipient 2211b of the memo, and a sender 2211c of the memo.

A memo adding button 2213 for adding a memo and a memo editing button 2214 for editing previously input memos may be displayed on the memo display screen 2210. The user may touch the memo adding button 2213 to add a new memo and touch the memo editing button 2214 for editing an existing memo. The user may touch the memos 2211 and 2212 displayed on the memo display screen 2210 to edit each of the memos.

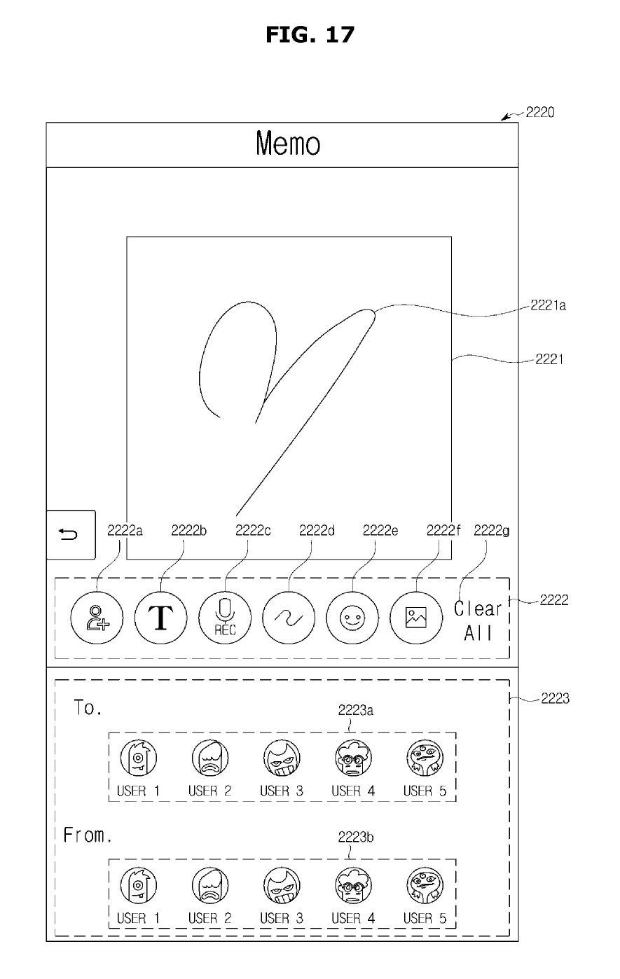

When a touch input is made on the memo adding button 2213, the refrigerator 1 may display a memo generation screen 2220 as illustrated in FIG. 17 on the touchscreen display 120.

The memo generation screen 2220 may include a memo display region 2221 in which a memo input by the user is displayed, a tool selection region 2222 for selecting a tool for generating a memo, and a tool display region 2223 in which a tool selected from the tool selection region 2222 is displayed.

A memo 2221a input by the user using a tool selected from the tool selection region 2222 may be displayed in the memo display region 2221.

Tools 2222a to 2222g that the user may user to generate a memo may be displayed in the tool selection region 2222. The tools 2222a to 2222g may include a recipient/sender input tool 2222a, a text input tool 2222b, a sound input tool 2222c, a drawing tool 2222d, a sticker input tool 2222e, a picture input tool 2222f, and a clearing tool 2222g.

A tool selected from the tool selection region 2222 may be displayed in the tool display region 2223. For example, when the text input tool 2222b is selected, a keyboard for inputting a text, a number, and/or a symbol may be displayed in the tool display region 2223, and when the sound input tool 2222c is selected, a record button to start recording may be displayed in the tool display region 2223. When the drawing tool 2222d is selected, various drawing tools such as a pen, a brush, and a spray may be displayed in the tool display region 2223, and when the sticker input tool 2222e is selected, stickers that may be input to the tool display region 2223 may be displayed.

When the recipient/sender input tool 2222a is selected, a recipient selection region 2223a for selecting a recipient of a memo and a sender selection region 2223b for selecting a sender of the memo may be displayed in the tool display region 2223. The plurality of users USER1 to USER5 may be displayed in each of the recipient selection region 2223a and the sender selection region 2223b, and the user may select a recipient of a memo and a sender of the memo from the plurality of users USER1 to USER5.

When a memo is added, the refrigerator 1 displays the added memo (1240).

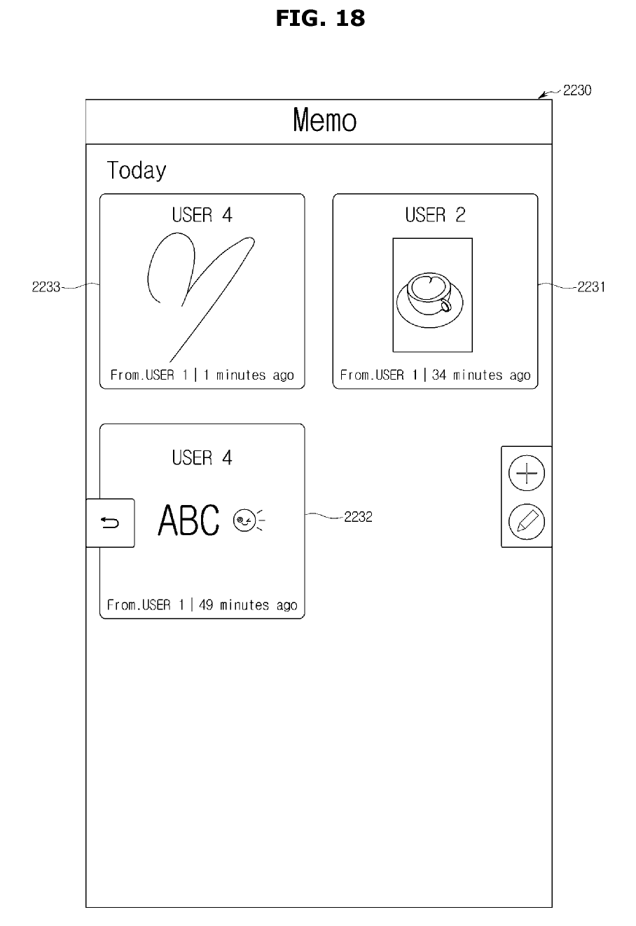

When the user adds a memo through the memo generation screen 2220, the refrigerator 1 may display the added memo on the touchscreen display 120. For example, the refrigerator 1 may display a memo display screen 2230 as illustrated in FIG. 18. Together with existing first memo 2231 and second memo 2232, a third memo 2233 newly input from the user may be displayed on the memo display screen 2230.

Then, the refrigerator 1 transmits memo data to the service server (1250), and the service server 3 transmits the received memo data to the user device 2 (1260).

When the memo data is received from the refrigerator 1, the service server 3 may store the received memo data and transmit the memo data to the user device 2. Particularly, the service server 3 may transmit the memo data to all of the users or transmit the memo data only to a sender and a recipient of a memo. For example, when the first user USER1 transmits a memo to the fourth user USER4, the service server 3 may transmit memo data to the user device 2 of the first user USER1 and the user device 2 of the fourth user USER4.

The user device 2 displays a memo indicated by the received memo data (1270).

The user device 2 may receive memo data from the service server 3 through the communicator 240 and store the received memo data in the storage 230. The user device 2 may display a memo on the touchscreen display 220 according to the user's touch input.

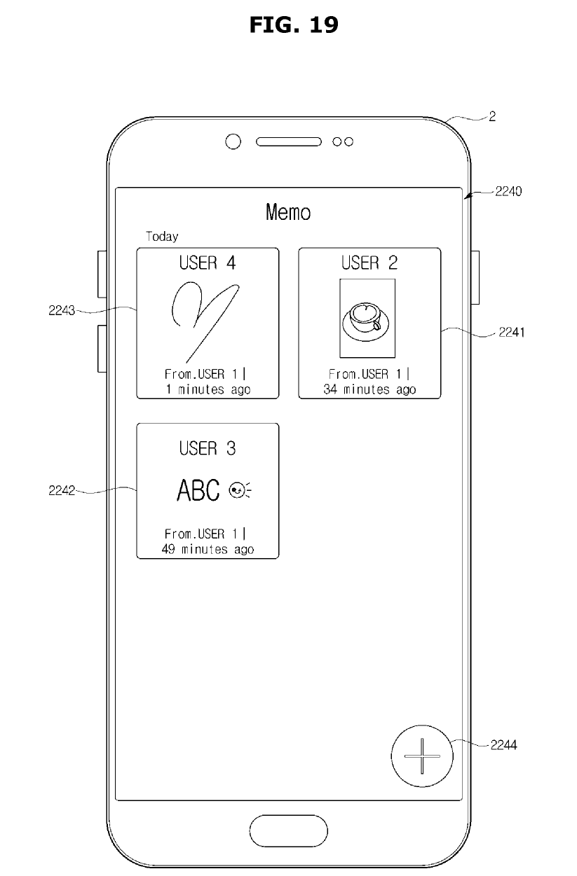

For example, the user device 2 may display a memo display screen 2240 as illustrated in FIG. 19. In addition to an existing first memo 2241 and a second memo 2242, a third memo 2243 received from the service server 3 may be displayed on the memo display screen 2240.

As another example, the user device 2 may selectively display only a memo of which a recipient or a sender is the user of the user device 2. For example, when the user of the user device 2 is the fourth user USER4, the user device 2 may selectively display only a memo of which a recipient or a sender is the fourth user USER4, that is, the third memo 2243.

A memo adding button 2244 for adding a memo may be displayed on the memo display screen 2240. The user may touch the memo adding button 2244 to add a new memo.

As described above, the refrigerator 1 may generate and display a memo according to a user's input and transmit the generated memo to the user device 2. Here, the memo may include a recipient and a sender thereof as well as content thereof.

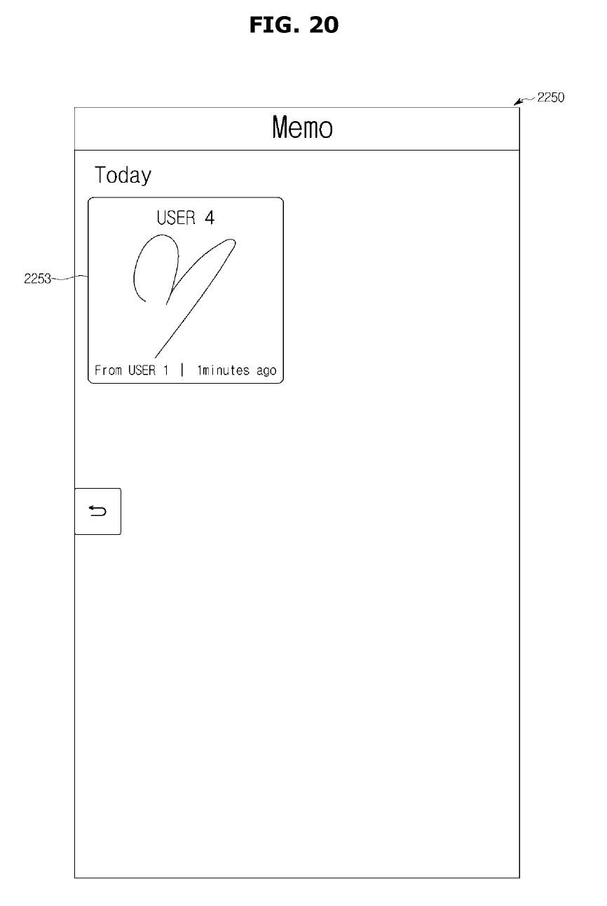

FIG. 20 illustrates another example of a memo display screen displayed on the touchscreen display included in the refrigerator according to one embodiment.

As described above, the refrigerator 1 may identify a user using speaker recognition, facial recognition, fingerprint recognition, iris recognition, vein recognition, and the like and display different home screens 2010 and 2020 according to an identified user.

The refrigerator 1 may identify a user and display a different memo display screen according to an identified user. Specifically, the refrigerator 1 may selectively display only a memo of which a recipient or a sender is the identified user.

For example, when the identified user is the fourth user USER4, the refrigerator 1 may selectively display only a memo of which a recipient or a sender is the fourth user USER4. As illustrated in FIG. 20, the refrigerator 1 may display a memo display screen 2250 including a third memo 2253 of which a recipient (or a sender) is the fourth user USER4.

As described above, the refrigerator 1 may identify the current user and display a different memo for a different user.

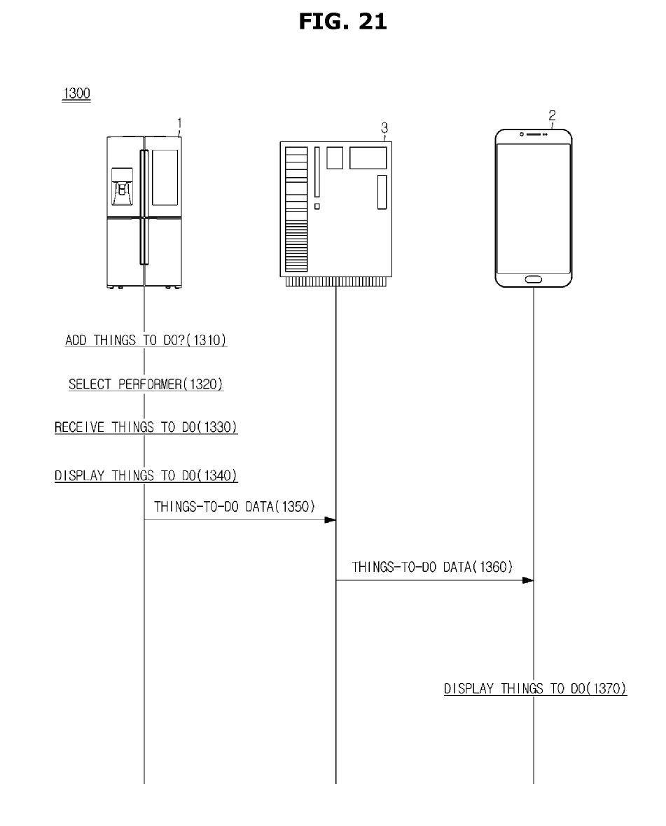

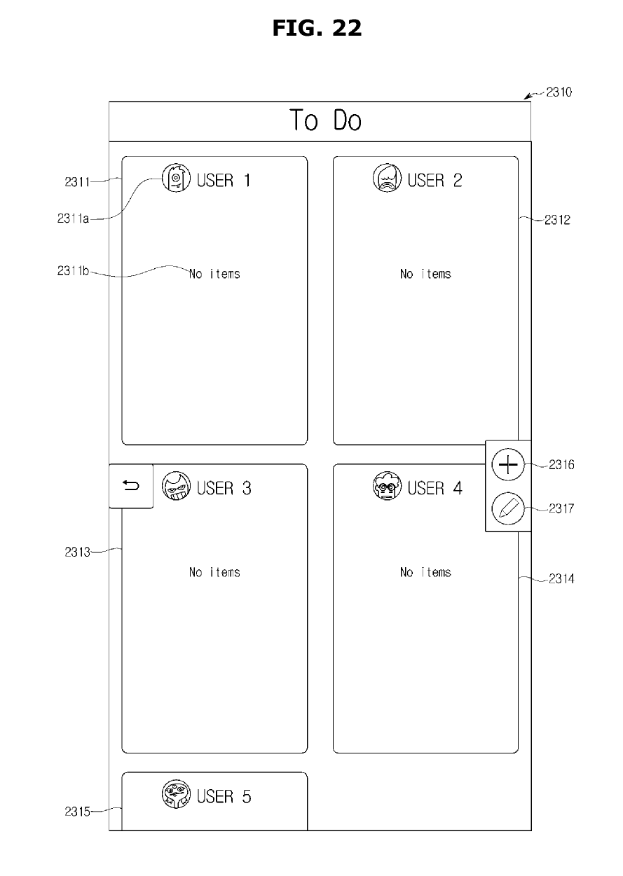

FIG. 21 illustrates a method of generating and displaying things to do by the refrigerator according to one embodiment. FIGS. 22, 23, 24, and 25 illustrate screens for generating and displaying things to do according to the method of generating and displaying things to do illustrated in FIG. 21.

The users may input things to do using the To-do application of the refrigerator 1, and the refrigerator 1 may display the things to do input by the users.

A things-to-do generating/displaying method (1300) in which the refrigerator 1 generates and displays things to do will be described with reference to FIGS. 21, 22, 23, 24, and 25.

The refrigerator 1 determines whether to add things to do (1310).

The refrigerator 1 may determine whether to add things to do according to a user's touch input through the touchscreen display 120. The users may run the To-do application to add things to do. For example, the user may make a touch input on the To-do GUI elements 2015 and 2025 displayed on the home screens 2010 and 2020. When touch inputs are made on the To-do GUI elements 2015 and 2025, the refrigerator 1 may determine to add things to do.

When adding things to do, the refrigerator 1 may receive selection on a performer of new things to do from the user (1320) and receive content of the new things to do (1330).

The refrigerator 1 may receive new things to do from the user through the touchscreen display 120.

The refrigerator 1 may display a things-to-do display screen 2310 as illustrated in FIG. 22. Things-to-do lists 2311 to 2315 for all of the users USER1 to USER5 may be displayed on the things-to-do display screen 2310. A first things-to-do list 2311 for the first user USER1, a second things-to-do list 2312 for the second user USER2, a third things-to-do list 2313 for the third user USER3, a fourth things-to-do list 2314 for the fourth user USER4, and a fifth things-to-do list 2315 for the fifth user USER5 may be displayed on the things-to-do display screen 2310.

Each of the things-to-do list may display a performer of the things to do and content of the things to do. For example, the first things-to-do list 2311 may include a performer indicator 2311a that indicates that the things to do should be performed by the first user USER 1 and content 2311b of the things to do of the first user USER1.

A things-to-do adding button 2316 for adding a new things-to-do list and a things-to-do editing button 2317 for editing the previously input things-to-do lists 2311 to 2315 may be displayed on the things-to-do display screen 2310. The user may touch the things-to-do adding button 2316 to add a new things-to-do list and may touch the things-to-do editing button 2317 for editing the existing things-to-do lists 2311 to 2315.

The user may touch the things-to-do lists 2311 to 2315 to add or edit the things to do of each of the users USER1 to USER5. For example, when inputting things to do of the first user USER1, the user may touch the first things-to-do list 2311 in which things to do of the first user USER1 are displayed.

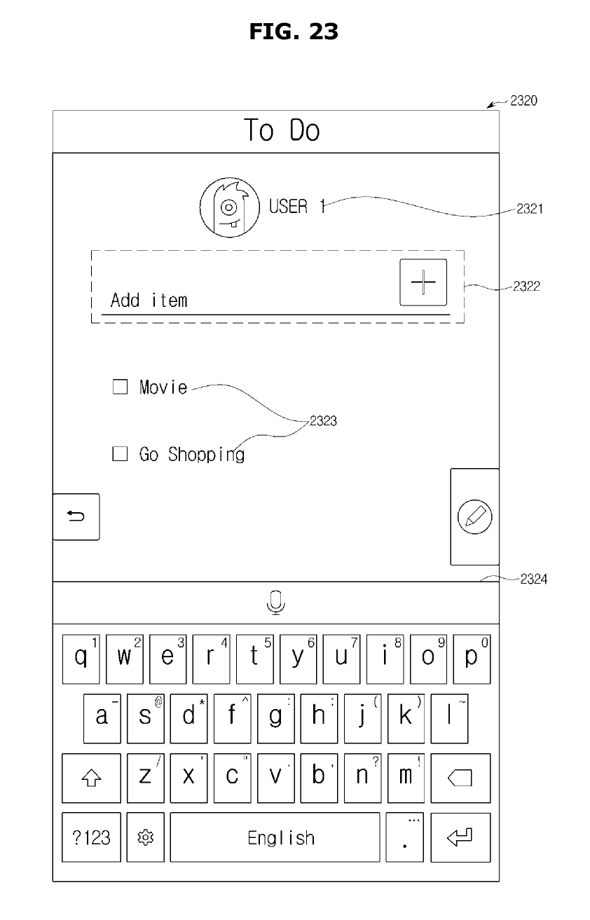

When a touch input is made on the things-to-do adding button 2316 or the things-to-do lists 2311 to 2315, the refrigerator 1 may display a things-to-do adding screen 2320 as illustrated in FIG. 23 on the touchscreen display 120.

The things-to-do adding screen 2320 may include a performer indicating region 2321 in which a user to perform the things to do is indicated, a things-to-do input region 2322 for inputting content of the things to do, a things-to-do display region 2323 in which content of already input things to do is displayed, and a keyboard 2324 for inputting things to do.

The user may use the keyboard 2324 to input new things to do to the things-to-do input region 2322. The things to do input by the user may be displayed in the things-to-do display region 2323.

When the things to do are added, the refrigerator 1 displays the added things to do on the touchscreen display 120 (1340).

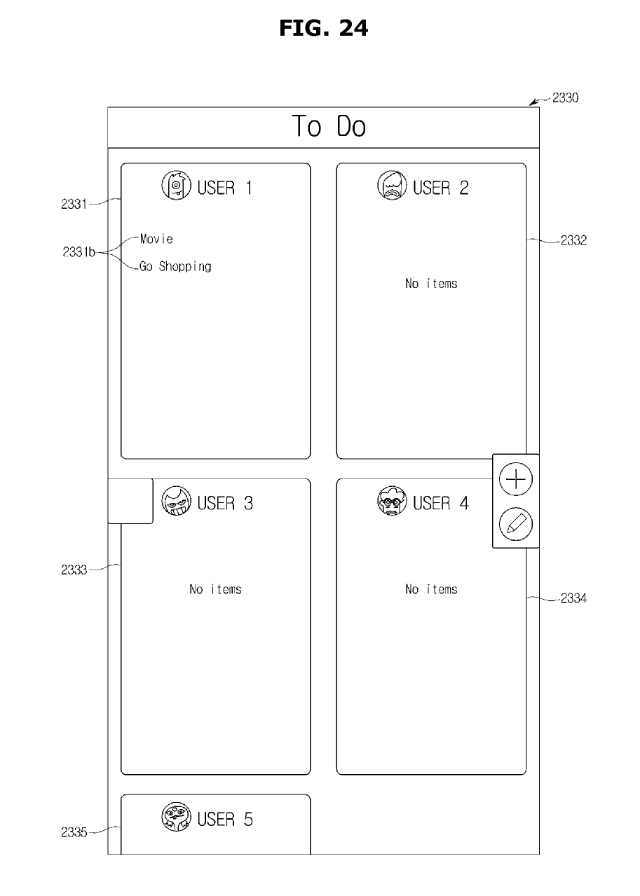

When the user adds the things to do through the things-to-do adding screen 2320, the refrigerator 1 may display the added things to do on the touchscreen display 120. For example, the refrigerator 1 may display a things-to-do display screen 2330 as illustrated in FIG. 24. The things-to-do display screen 2330 may display a first things-to-do list 2331, a second things-to-do list 2332, a third things-to-do list 2333, a fourth things-to-do list 2334, and a fifth things-to-do list 2335, and content 2331b of newly input things to do may be displayed in the first things-to-do list 2331.

Then, the refrigerator 1 transmits things-to-do data to the service server 3 (1350), and the service server 3 transmits the received things-to-do data to the user device 2 (1360).

When the things-to-do data is received from the refrigerator 1, the service server 3 may store the received things-to-do data and transmits the things-to-do data to the user device 2. Particularly, the service server 3 may transmit the things-to-do data to all of the users or transmit the things-to-do data only to a performer of the things to do. For example, when the performer of things to do is the first user USER1, the service server 3 may transmit the things-to-do data to the user device 2 of the first user USER1.

The user device 2 displays the things to do indicated by the received things-to-do data (1370).

The user device 2 may receive the things-to-do data from the service server 3 through the communicator 240 and store the received things-to-do data in the storage 230. The user device 2 may display the things to do on the touchscreen display 220 according to the user's touch input.

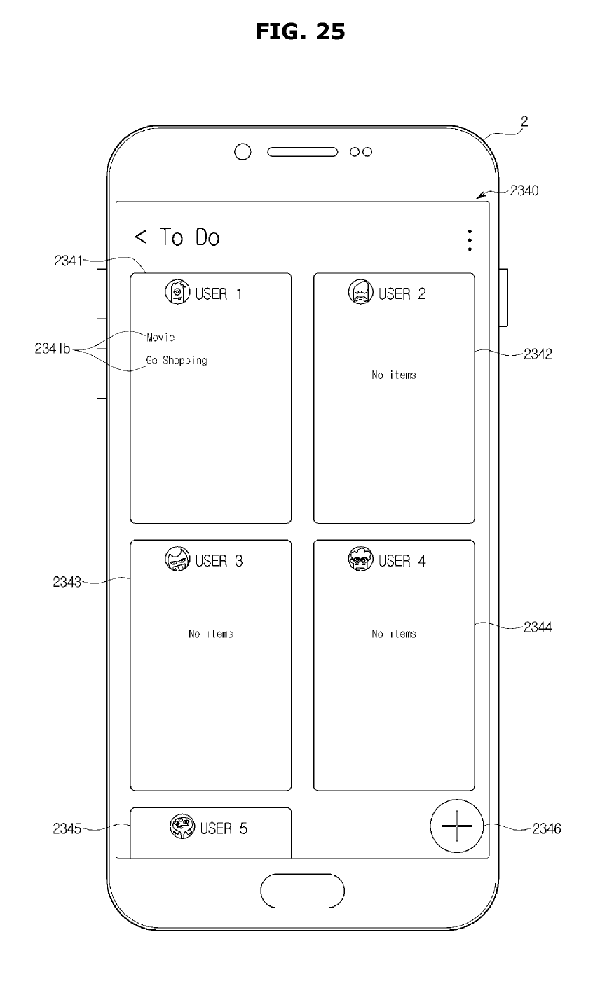

For example, the user device 2 may display a things-to-do display screen 2340 as illustrated in FIG. 25. A first things-to-do list 2341, a second things-to-do list 2342, a third things-to-do list 2343, a fourth things-to-do list 2344, and a fifth things-to-do list 2345 respectively indicating things to do of the first user USER1, the second user USER2, the third user USER3, the fourth user USER4, and the fifth use USER5 may be displayed on the things-to-do display screen 2340. Particularly, content 2341b of things to do received from the service server 3 may be displayed in the first things-to-do list 2341.

As another example, the user device 2 may selectively display only things to do of which a performer is a user of the user device 2. For example, when the user of the user device 2 is the first user USER1, the user device 2 may selectively display only the first things-to-do list 2341 of which a performer is the first user USER1.

A things-to-do adding button 2346 for adding things to do may be displayed on the things-to-do display screen 2340. The user may touch the things-to-do adding button 2346 to add new things to do.

As described above, the refrigerator 1 may generate and display things to do according to a user's input and transmit the generated things to do to the user device 2. Here, the things to do may include a performer thereof as well as content thereof.

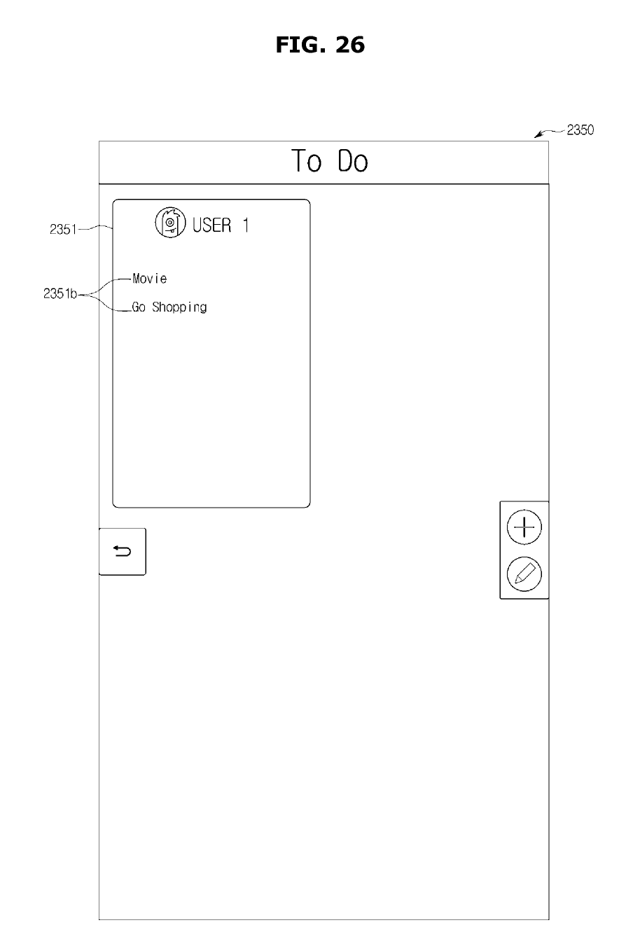

FIG. 26 illustrates another example of a things-to-do display screen displayed on the touchscreen display included in the refrigerator according to one embodiment.

As described above, the refrigerator 1 may identify a user using speaker recognition, facial recognition, fingerprint recognition, iris recognition, vein recognition, and the like and display different home screens 2010 and 2020 according to an identified user.

The refrigerator 1 may identify a user and display a different things-to-do display screen according to an identified user. Specifically, the refrigerator 1 may selectively display only things to do of which a performer is the identified user.

For example, when the identified user is the first user USER1, the refrigerator 1 may selectively display only things to do of which a performer is the first user USER1. As illustrated in FIG. 26, the refrigerator 1 may display a things-to-do display screen 2350, and a first things-to-do list 2351 of which a performer is the first user USER1 may be displayed on the things-to-do display screen 2350. When the things-to-do display screen 2350 is compared with the things-to-do display screen 2330 (see FIG. 24) illustrated in FIG. 24, while all of the things-to-do lists 2331 to 2335 (see FIG. 24) of all of the users USER1 to USER5 are displayed on the things-to-do screen 2330 (see FIG. 24), only the first things-to-do list 2351 including things to do 2351b of the first user USER1 is selectively displayed on the things-to-do display screen 2350 of FIG. 26.

As described above, the refrigerator 1 may identify the current user and display a different things-to-do list for a different user.

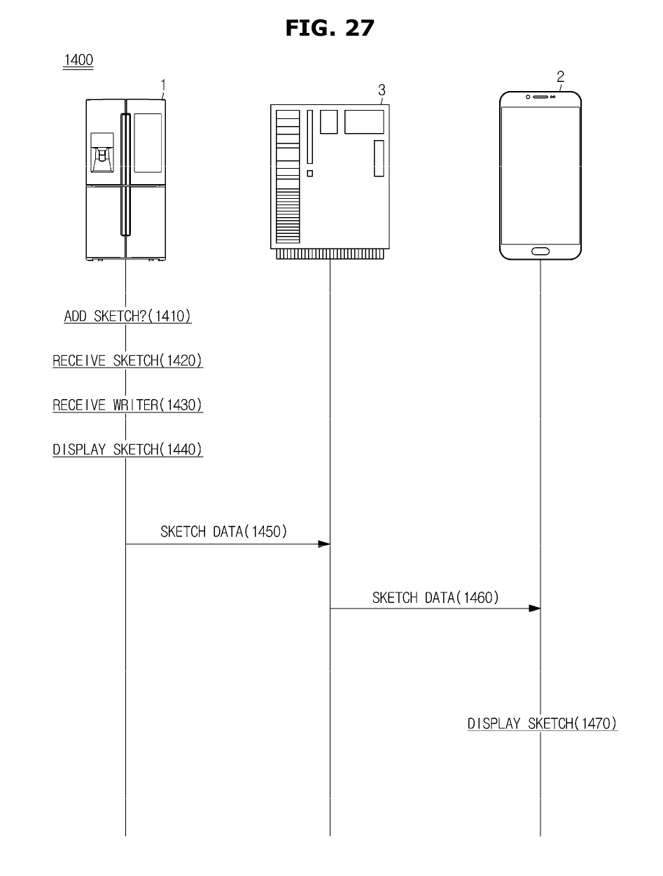

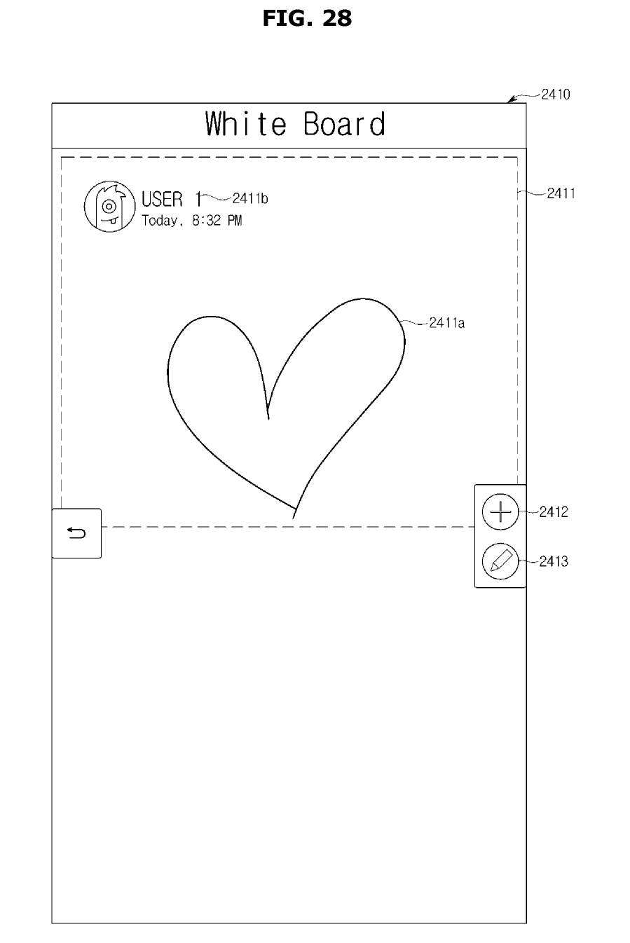

FIG. 27 illustrates a method of generating and displaying a sketch by the refrigerator according to one embodiment. FIGS. 28, 29, 30, and 31 illustrate screens for generating and displaying a sketch according to the method of generating and displaying a sketch illustrated in FIG. 27.

The users may input a sketch by using the sketch application of the refrigerator 1, and the refrigerator 1 may display the sketch input by the users.

A sketch generating/displaying method (1400) in which the refrigerator 1 generates and displays a sketch will be described with reference to FIGS. 27, 28, 29, 30, and 31.

The refrigerator 1 determines whether to add a sketch (1410).

The refrigerator 1 may determine whether to add a sketch according to a user's touch input through the touchscreen display 120. The users may run the sketch application to add a sketch. For example, the user may make touch inputs on the sketch GUI elements 2016 and 2026 displayed on the home screens 2010 and 2020. When touch inputs are made on the sketch GUI elements 2016 and 2026, the refrigerator 1 may determine to add a sketch.

When adding a sketch, the refrigerator 1 receives a new sketch from a user (1420) and receives a writer of the new sketch (1430).

The refrigerator 1 may receive a new sketch from a user through the touchscreen display 120.

The refrigerator 1 may display a sketch display screen 2410 illustrated in FIG. 28. Sketches (a first sketch 2411 of FIG. 28) input by the users may be displayed on the sketch display screen 2410. Each of the sketches may include a sketched image 2411a and a writer 2411b of the sketch.

A sketch adding button 2412 for adding a sketch and a sketch editing button 2413 for editing previously input sketches may be displayed on the sketch display screen 2410. The user may touch the sketch adding button 2412 to add a new sketch and touch the sketch editing button 2413 to edit an existing sketch. The user may touch a displayed sketch to edit the sketch.

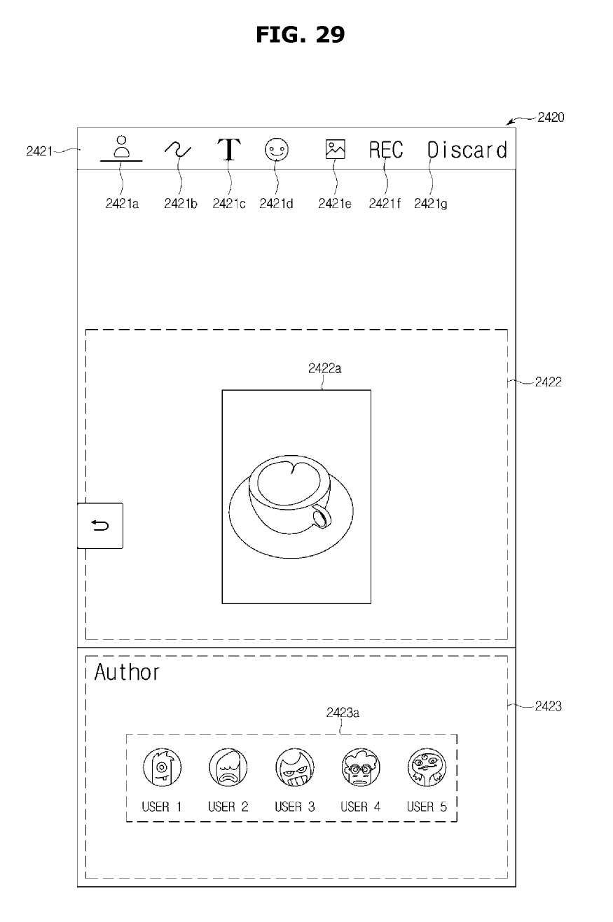

When a touch input is made on the sketch adding button 2412, the refrigerator 1 may display a sketch generation screen 2420 as illustrated in FIG. 29 on the touchscreen display 120.

The sketch generation screen 2420 may include a tool selection region 2421 for selecting a tool for generating a sketch, a sketch display region 2422 in which a sketch input by a user is displayed, and a tool display region 2423 in which a tool selected from the tool selection region 2421 is displayed.

Tools 2421a to 2421g that the user may use to generate a sketch may be displayed in the tool selection region 2421. The tools 2421a to 2421g may include a writer input tool 2421a, a drawing tool 2421b, a text input tool 2421c, a sticker input tool 2421d, a picture input tool 2421e, a video input tool 2421f, and a discarding tool 2421g.

A sketch 2422a input by the user using a tool selected from the tool selection region 2421 may be displayed in the sketch display region 2422.

A tool selected from the tool selection region 2421 may be displayed in the tool display region 2423. For example, when the drawing tool 2421b is selected, various drawing tools such as a pen, a brush, and a spray may be displayed in the tool display region 2423, and when the text input tool 2421c is selected, a keyboard for inputting a text, a number, and/or a symbol may be displayed in the tool display region 2423. When the sticker input tool 2421d is selected, stickers that may be input to the tool display region 2423 may be displayed, and when the picture input tool 2421e is selected, various pictures may be displayed in the tool display region 2423.

When the writer input tool 2421a is selected, a writer selection region 2423a for selecting a writer of a sketch may be displayed in the tool display region 2423. The plurality of users USER1 to USER5 may be displayed in the writer selection region 2423a, and the user may select a writer of a sketch from the plurality of users USER1 to USER5.

When a sketch is added, the refrigerator 1 displays the added sketch (1440).

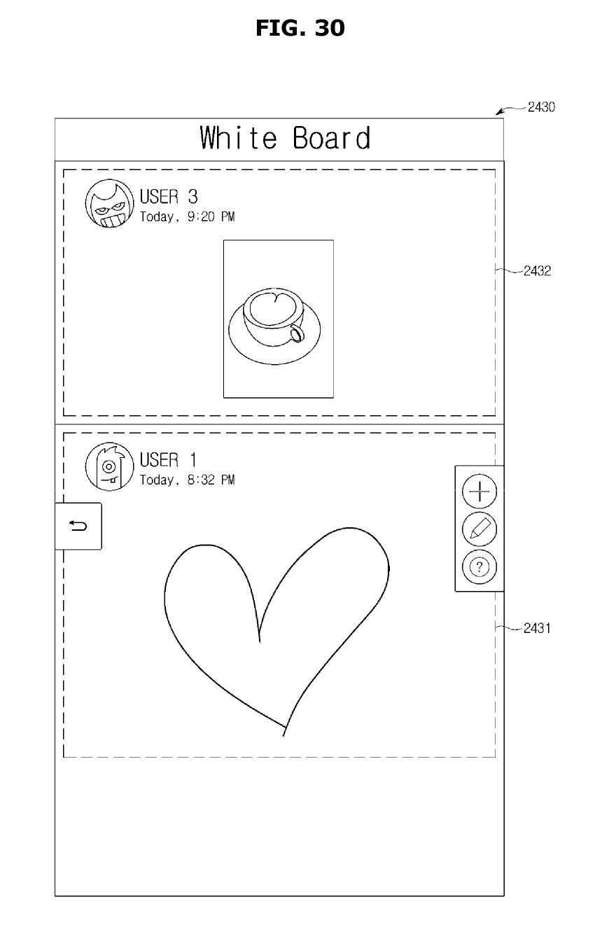

When the user adds a sketch through the sketch generation screen 2420, the refrigerator 1 may display the added sketch on the touchscreen display 120. For example, the refrigerator 1 may display a sketch display screen 2430 illustrated in FIG. 30. Together with an existing first sketch 2431, a second sketch 2432 newly input from the user may be displayed on the sketch display screen 2430.

Then, the refrigerator 1 transmits sketch data to the service server 3 (1450), and the service server 3 transmits the received sketch data to the user device 2 (1460).

When the sketch data is received from the refrigerator 1, the service server 3 may store the received sketch data and transmit the sketch data to the user device 2. Particularly, the service server 3 may transmit the sketch data to all of the users or transmit the sketch data only to a writer of a sketch. For example, when the third user USER3 is a writer of a sketch, the service server 3 may transmit sketch data to the user device 2 of the third user USER3.

The user device 2 displays a sketch indicated by the received sketch data (1470).

The user device 2 may receive sketch data from the service server 3 through the communicator 240 and store the received sketch data in the storage 230. The user device 2 may display a sketch on the touchscreen display 220 according to the user's touch input.

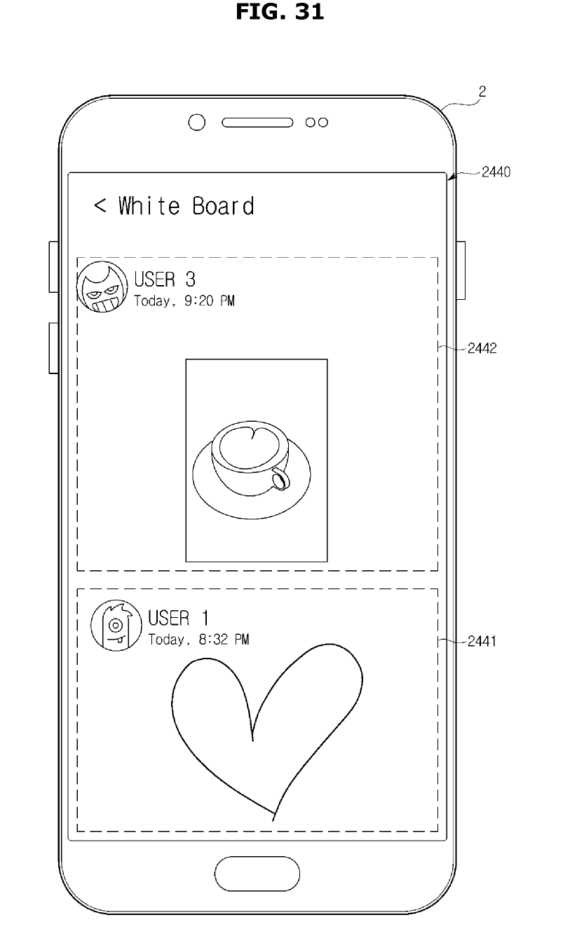

For example, the user device 2 may display a sketch display screen 2440 as illustrated in FIG. 31. In addition to an existing first sketch 2441, a second sketch 2442 received from the service server 3 may be displayed on the sketch display screen 2440.

As another example, the user device 2 may selectively display only a sketch of which a writer is the user of the user device 2. For example, when the user of the user device 2 is the third user USER3, the user device 2 may selectively display only a sketch of which a writer is the third user USER3, that is, the second sketch 2442.

A sketch adding button 2443 for adding a sketch may be displayed on the sketch display screen 2440. The user may touch the sketch adding button 2443 to add a new sketch.

As described above, the refrigerator 1 may generate and display a sketch according to a user's input and transmit the generated sketch to the user device 2. Here, the sketch may include a writer thereof as well as a sketched image.

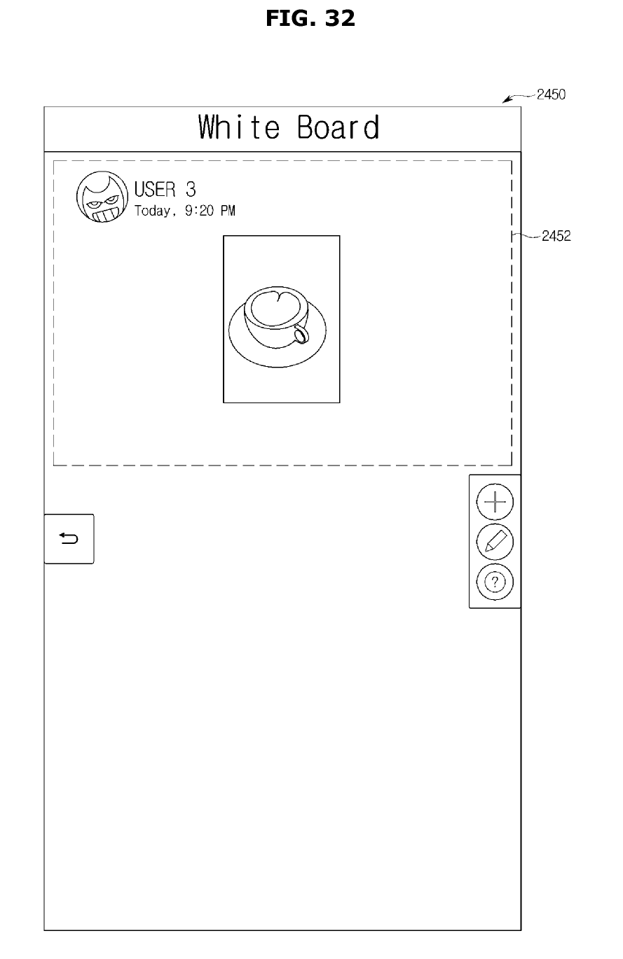

FIG. 32 illustrates another example of a sketch display screen displayed on the touchscreen display included in the refrigerator according to one embodiment.

As described above, the refrigerator 1 may identify a user using speaker recognition, facial recognition, fingerprint recognition, iris recognition, vein recognition, and the like and display different home screens 2010 and 2020 according to an identified user.

The refrigerator 1 may identify a user and display a different sketch display screen according to an identified user. Specifically, the refrigerator 1 may selectively display only a sketch of which a writer is the identified user.

For example, when the identified user is the third user USER3, the refrigerator 1 may selectively display only a sketch of which a writer is the third user USER3. As illustrated in FIG. 32, the refrigerator 1 may display a second sketch 2452 of which a writer is the third user USER3 on a sketch display screen 2450.

As described above, the refrigerator 1 may identify the current user and display a different sketch for a different user.

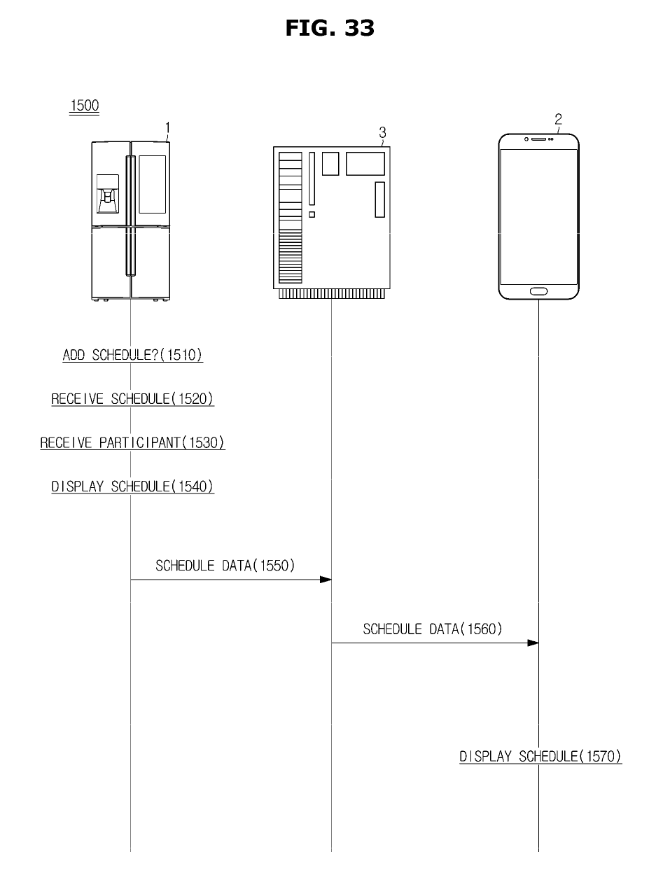

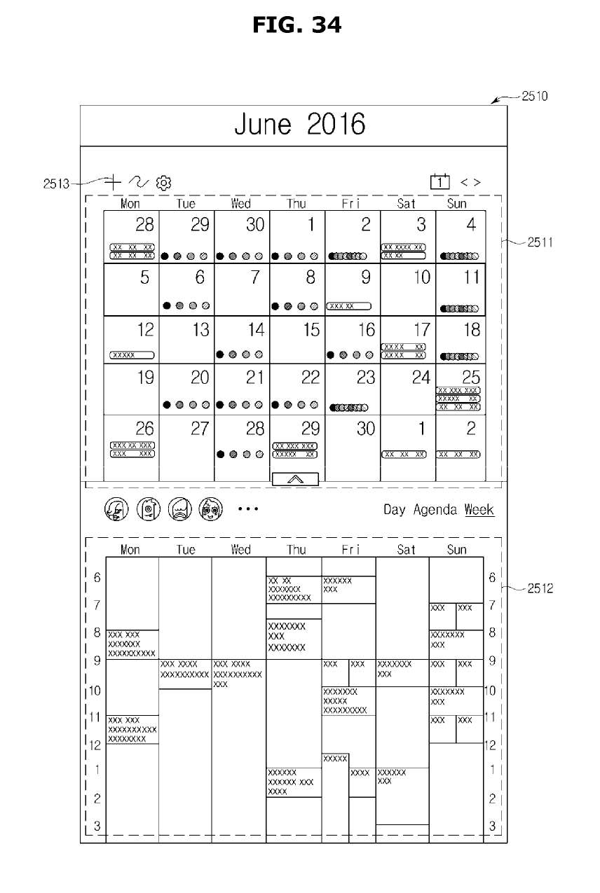

FIG. 33 illustrates a method of generating and displaying a schedule by the refrigerator according to one embodiment. FIGS. 34, 35, and 36 illustrate screens for generating and displaying a schedule according to the method of generating and displaying a schedule illustrated in FIG. 33.

The users may input a schedule by using the scheduler application of the refrigerator 1, and the refrigerator 1 may display the schedule input by the users.

A schedule generating/displaying method (1500) in which the refrigerator 1 generates and displays a schedule will be described with reference to FIGS. 33, 34, 35, and 36.

The refrigerator 1 determines whether to add a schedule (1510).

The refrigerator 1 may determine whether to add a schedule according to a user's touch input through the touchscreen display 120. The users may run the scheduler application to add a schedule. For example, the user may make touch inputs on the scheduler GUI elements 2013 and 2023 displayed on the home screens 2010 and 2020. When touch inputs are made on the scheduler GUI elements 2013 and 2023, the refrigerator 1 may determine to add a schedule.

When adding a schedule, the refrigerator 1 may receive a new schedule from a user (1520) and receive a participant in the schedule (1530) from the user.

The refrigerator 1 may receive a new schedule from a user through the touchscreen display 120. The user may generate a schedule and designate a specific user as a participant in the schedule. For example, the first user USER1 may generate a schedule and designate the second user USER2 as a participant in the schedule.

The refrigerator 1 may display a schedule display screen 2510 as illustrated in FIG. 34. The schedule display screen 2510 may include a monthly schedule display region 2511 in which monthly schedules of the users are displayed and a weekly schedule display region 2512 in which weekly schedules of the users are displayed. A schedule of the user in a month to which the current date belongs may be displayed by date in the monthly schedule display region 2511, and a schedule of the user in a week to which the current date belongs may be displayed by time in the weekly schedule display region 2512.

A schedule adding button 2513 for adding a schedule may be displayed on the schedule display screen 2510. The user may touch the schedule adding button 2513 to add a new schedule. The user may touch schedules displayed on the schedule display screen 2510 to edit the schedules.

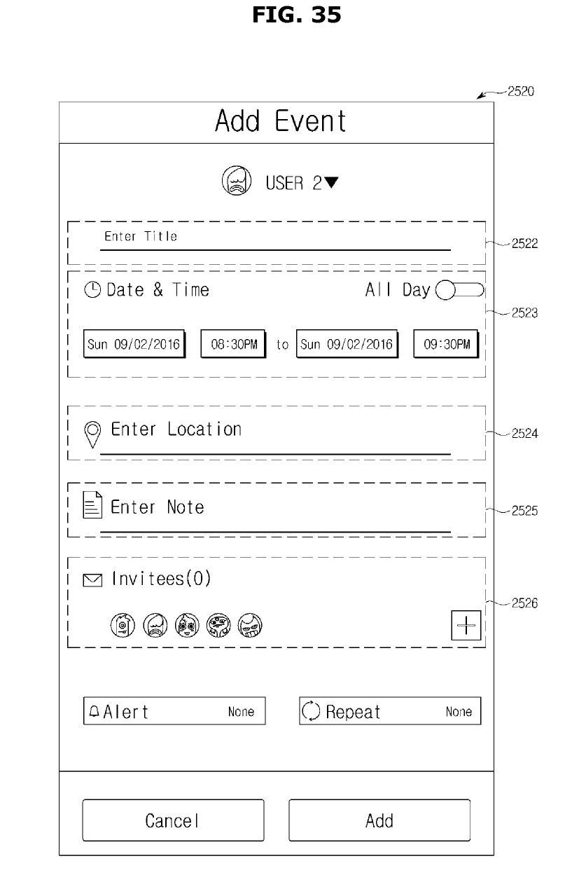

When a touch input is made on the schedule adding button 2513, the refrigerator 1 may display a schedule generation screen 2520 as illustrated in FIG. 35 on the touchscreen display 120.

The schedule generation screen 2520 may include a writer selection region 2521 for selecting a writer of a schedule, a title input region 2522 for inputting a title of a schedule, a date/time input region 2523 for inputting a date and time of a schedule, a location input region 2524 for inputting a location of a schedule, a note input region 2525 for inputting a brief description of a schedule, and a participant selection region 2526 for selecting a participant in a schedule.

The user may select a writer of a schedule in the writer selection region 2521 and input a title, a date/time, a location, and a note of the schedule in the title input region 2522, the date/time input region 2523, the location input region 2524, and the note input region 2525, respectively.

The user may select a participant in the schedule in the participant selection region 2526. The plurality of users USER1 to USER5 may be displayed in the participant selection region 2526, and the user may select a participant in the schedule among the plurality of users USER1 to USER5 displayed in the participant selection region 2526.

When a schedule is added, the refrigerator 1 displays the added schedule (1540).

When the user adds a schedule through the schedule generation screen 2520, the refrigerator 1 may display the added schedule on the touchscreen display 120.

Then, the refrigerator 1 transmits schedule data to the service server 3 (1550), and the service server 3 transmits the received schedule data to the user device 2 (1560).

When the schedule data is received from the refrigerator 1, the service server 3 may store the received schedule data and transmit the schedule data to the user device 2. Particularly, the service server 3 may transmit the schedule data to all of the users or transmit the schedule data only to a writer of the schedule and a participant in the schedule. For example, when the third user USER3 participates in a schedule of the first user USER1, the service server 3 may transmit the schedule data to the user device 2 of the first user USER1 and the user device 2 of the third user USER3.

The user device 2 displays a schedule indicated by the received schedule data (1570).

The user device 2 may receive schedule data from the service server 3 through the communicator 240 and store the received schedule data in the storage 230. The user device 2 may display the schedule on the touchscreen display 220 according to the user's touch input.

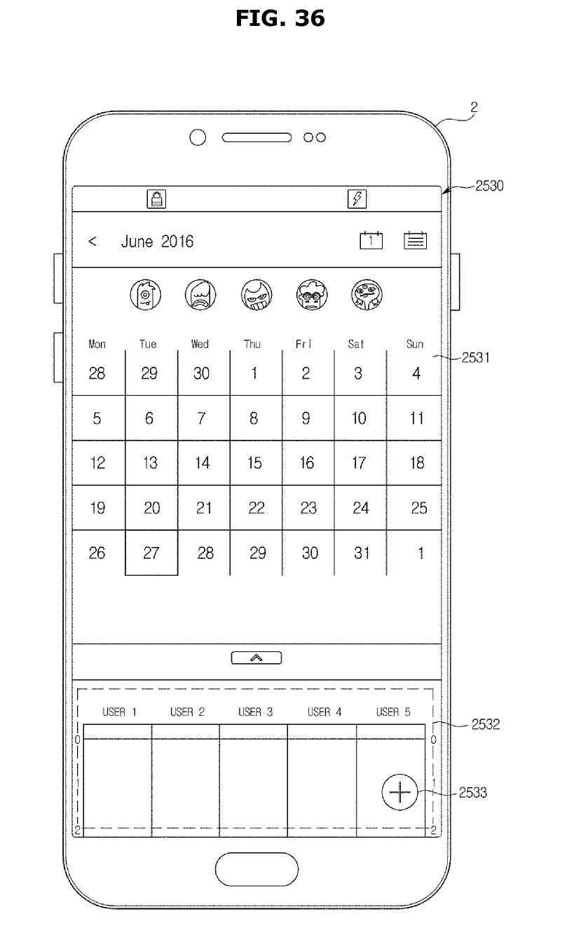

For example, the user device 2 may display a schedule display screen 2530 as illustrated in FIG. 36. The schedule display screen 2530 may include a monthly schedule display region 2531 in which monthly schedules of the users are displayed and a daily schedule display region 2532 in which daily schedules of the users are displayed.

As another example, the user device 2 may selectively display only a schedule of which a writer or a participant is the user of the user device 2. For example, when the user of the user device 2 is the third user USER3, the user device 2 may selectively display only a schedule of which a writer or a participant is the third user USER3.

A schedule adding button 2533 for adding a schedule may be displayed on the schedule display screen 2530. The user may touch the schedule adding button 2533 to add a new schedule.

As described above, the refrigerator 1 may generate and display a schedule according to a user's input and transmit the generated schedule to the user device 2. Here, the schedule may include a writer of the schedule and a participant in the schedule as well as content thereof.

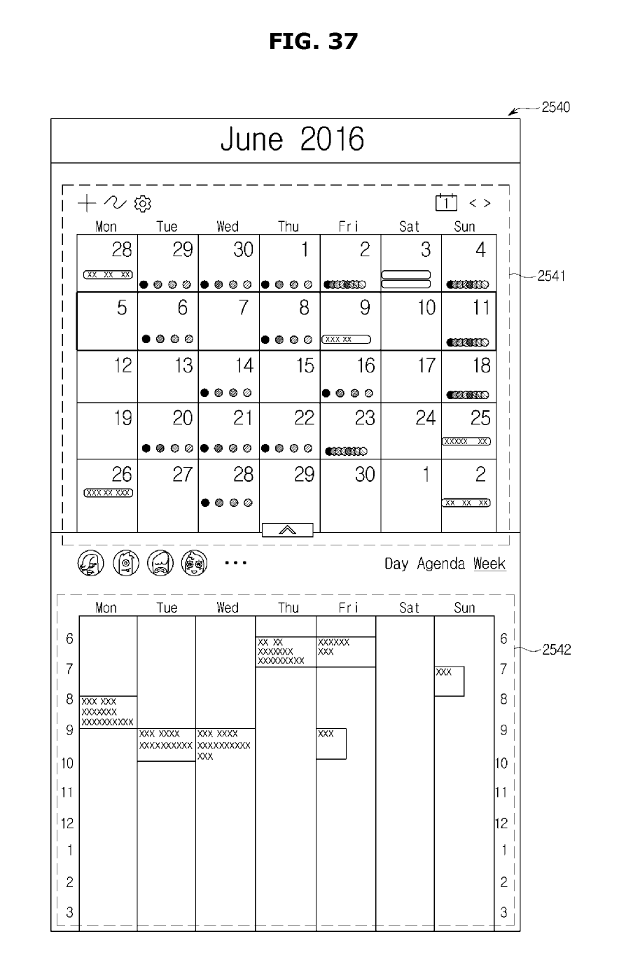

FIG. 37 illustrates another example of a schedule display screen displayed on the touchscreen display included in the refrigerator according to one embodiment.

As described above, the refrigerator 1 may identify a user using speaker recognition, facial recognition, fingerprint recognition, iris recognition, vein recognition, and the like and display different home screens 2010 and 2020 according to an identified user.

The refrigerator 1 may identify a user and display a different schedule display screen according to an identified user. Specifically, the refrigerator 1 may selectively display only a schedule of which a writer or a participant is the identified user.

For example, when the identified user is the third user USER3, the refrigerator 1 may selectively display only a schedule of which a writer or a participant is the third user USER3. As illustrated in FIG. 37, the refrigerator 1 may display a schedule of which a writer or a participant is the third user USER3 in a monthly schedule display region 2541 and a weekly schedule display region 2542 of a schedule display screen 2540.

As described above, the refrigerator 1 may identify the current user and display a different schedule for a different user.

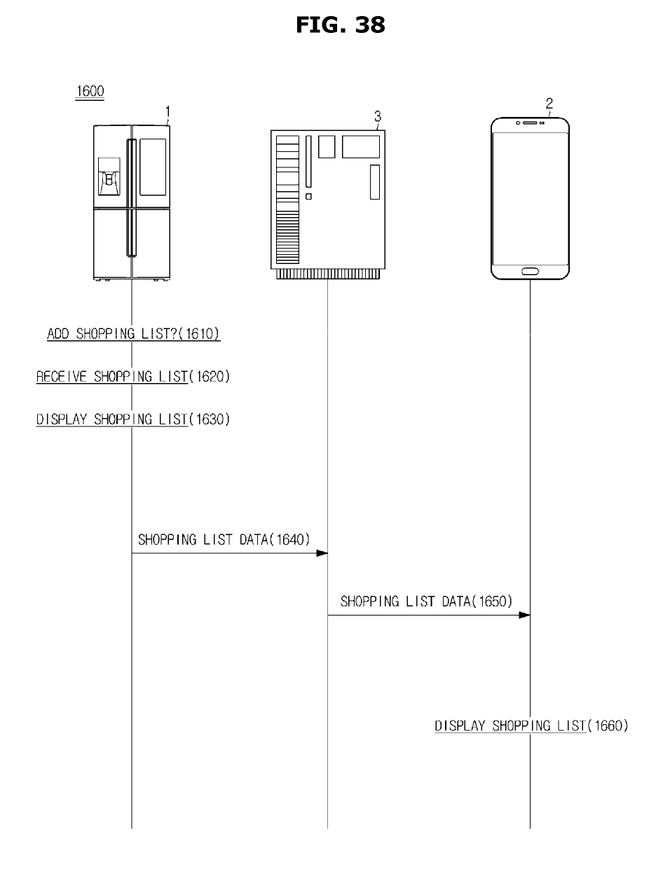

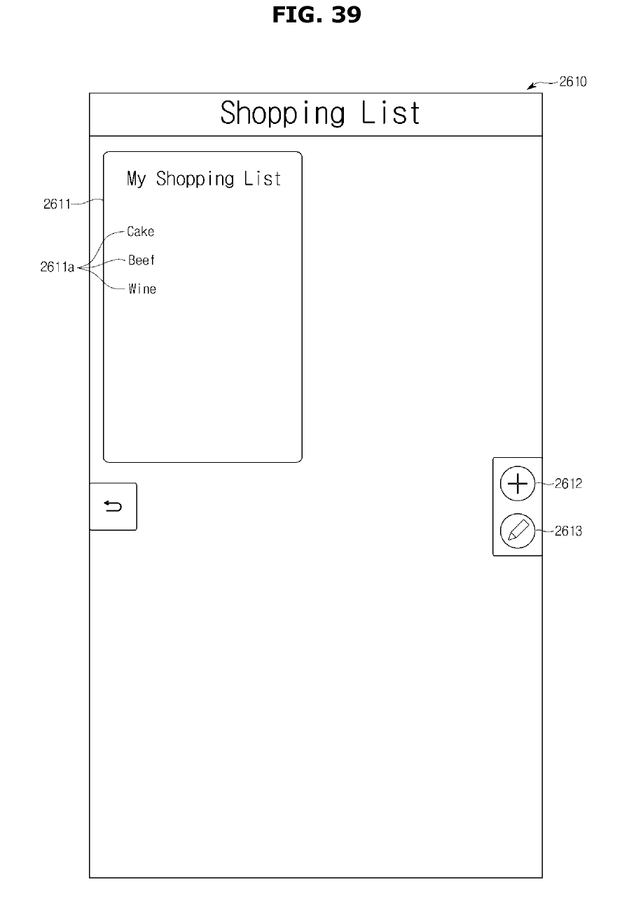

FIG. 38 illustrates a method of generating and displaying a shopping list by the refrigerator according to one embodiment. FIGS. 39, 40, 41, and 42 illustrate screens for generating and displaying a shopping list according to the method of generating and displaying a shopping list illustrated in FIG. 38.

The users may input a shopping list by using the shopping list application of the refrigerator 1, and the refrigerator 1 may display the shopping list input by the users.

A shopping list generating/displaying method (1600) in which the refrigerator 1 generates and displays a shopping list will be described with reference to FIGS. 38, 39, 40, 41, and 42.

The refrigerator 1 determines whether to add a shopping list (1610).

The refrigerator 1 may determine whether to add a shopping list according to a user's touch input through the touchscreen display 120. The users may run the shopping list application to add a shopping list. For example, the user may make touch inputs on the shopping list GUI elements 2018 and 2028 displayed on the home screens 2010 and 2020. When touch inputs are made on the shopping list GUI elements 2018 and 2028, the refrigerator 1 may determine to add a shopping list.

When adding a shopping list, the refrigerator 1 may receive a new shopping list from a user (1620).

The refrigerator 1 may receive a new shopping list from a user through the touchscreen display 120.

The refrigerator 1 may display a shopping list display screen 2610 as illustrated in FIG. 39. A first shopping list 2611 input by the users may be displayed on the shopping list display screen 2610. Items (products) 2611a to be shopped by the user may be indicated in the shopping list 2611.

A shopping list adding button 2612 for adding a shopping list and a shopping list editing button 2613 for editing previously input shopping lists may be displayed on the shopping list display screen 2610. The user may touch the shopping list adding button 2612 to add a new shopping list and touch the shopping list editing button 2613 to edit an existing shopping list. The user may touch the shopping list 2611 displayed on the shopping list display screen 2610 and edit the shopping list.

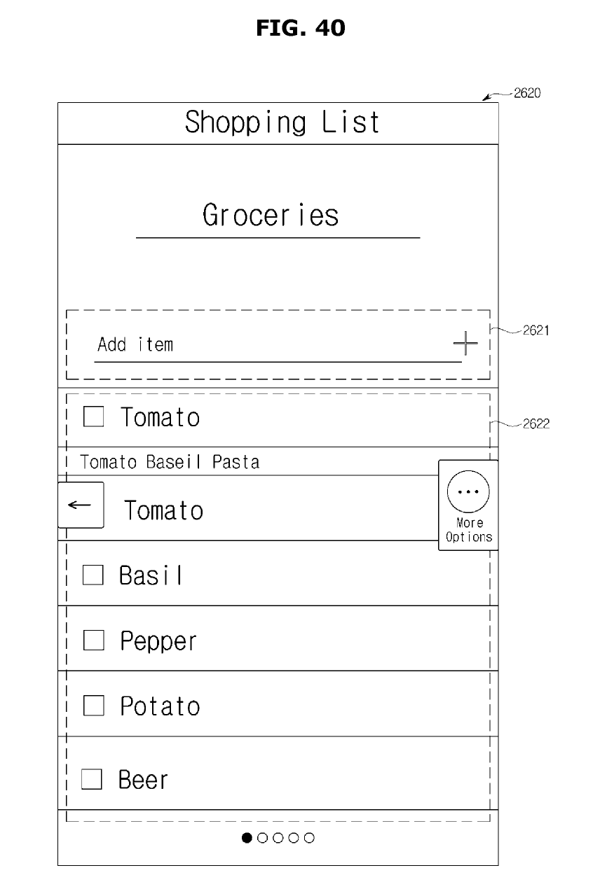

When a touch input is made on the shopping list adding button 2612, the refrigerator 1 may display a shopping list generation screen 2620 as illustrated in FIG. 40 on the touchscreen display 120.

The shopping list generation screen 2620 may include a shopping item input region 2621 in which shopping items (products) that are being input by the user are displayed, and a shopping item display region 2622 in which the shopping items (products) input by the user are displayed. The user may input items (products) to be shopped in the shopping item input region 2621, and the input shopping items (products) may be added to a shopping list and displayed in the shopping item display region 2622.

The adding of the shopping list is not limited to being directly generated by a user through the shopping list generation screen 2620. For example, a shopping list may be added through a recipe application. The user may search for a recipe using the recipe application. The recipe may include food ingredients as well as a cooking method. The refrigerator 1 may extract food ingredients included in the recipe from the recipe application and generate a shopping list including the extracted food ingredients.

When a shopping list is added, the refrigerator 1 displays the added shopping list (1630).

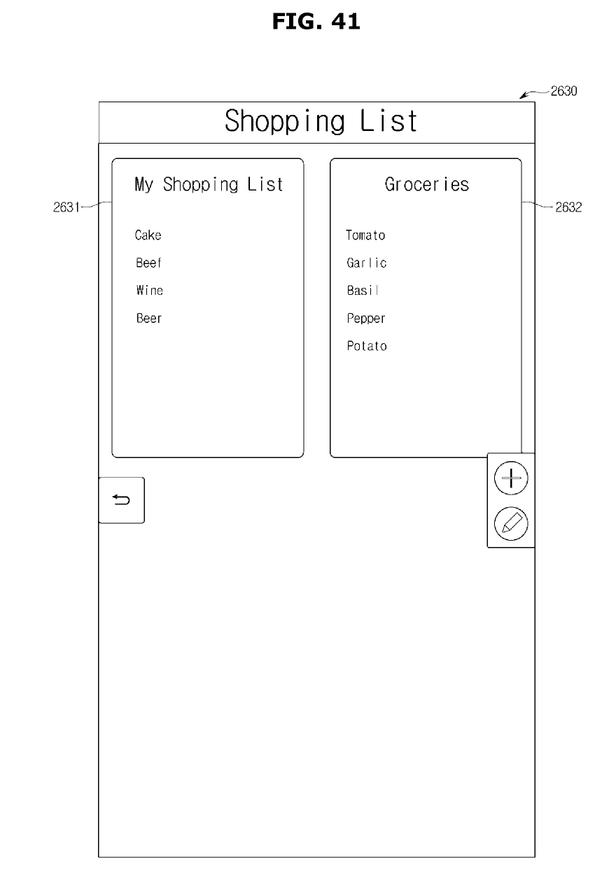

When the user adds a shopping list through the shopping list generation screen 2620, the refrigerator 1 may display the added shopping list on the touchscreen display 120. For example, the refrigerator 1 may display a shopping list display screen 2630 as illustrated in FIG. 41. Together with an existing first shopping list 2631, a second shopping list 2643 newly input by the user may be displayed on the shopping list display screen 2630.

Then, the refrigerator 1 transmits shopping list data to the service server 3 (1640), and the service server 3 transmits the received shopping list data to the user device 2 (1650).

When the shopping list data is received from the refrigerator 1, the service server 3 may store the received shopping list data and transmit the shopping list data to the user device 2.

The user device 2 displays a shopping list indicated by the received shopping list data (1660).

The user device 2 may receive the shopping list data from the service server 3 through the communicator 240 and store the received shopping list data in the storage 230. The user device 2 may display a shopping list on the touchscreen display 220 according to the user's touch input.

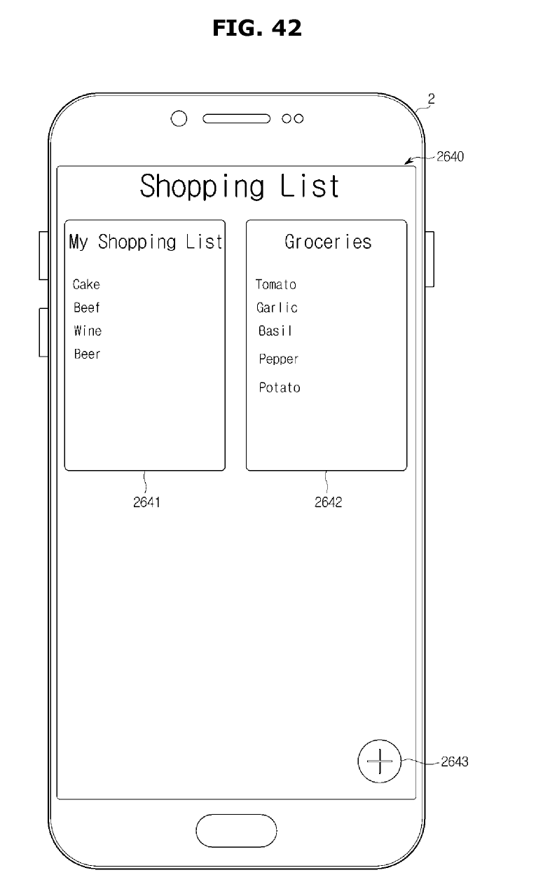

For example, the user device 2 may display a shopping list display screen 2640 as illustrated in FIG. 42. In addition to an existing first shopping list 2641, a second shopping list 2642 received from the service server 3 may be displayed on the shopping list display screen 2640.

A shopping list adding button 2643 for adding a shopping list may be displayed on the shopping list display screen 2640. The user may touch the shopping list adding button 2643 to add a new shopping list.

As described above, the refrigerator 1 may generate and display a shopping list according to a user's input and transmit the generated shopping list to the user device 2.

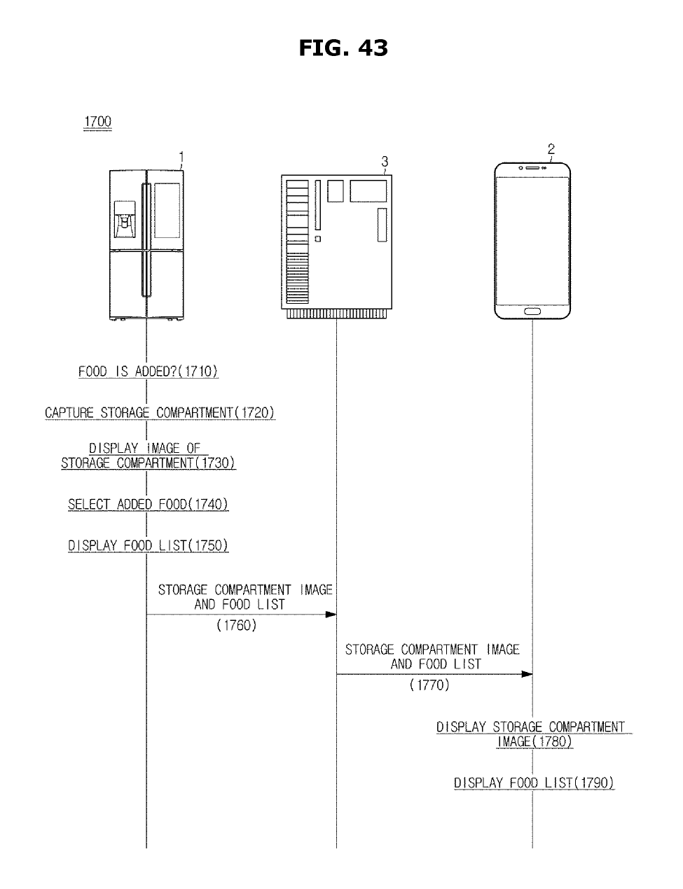

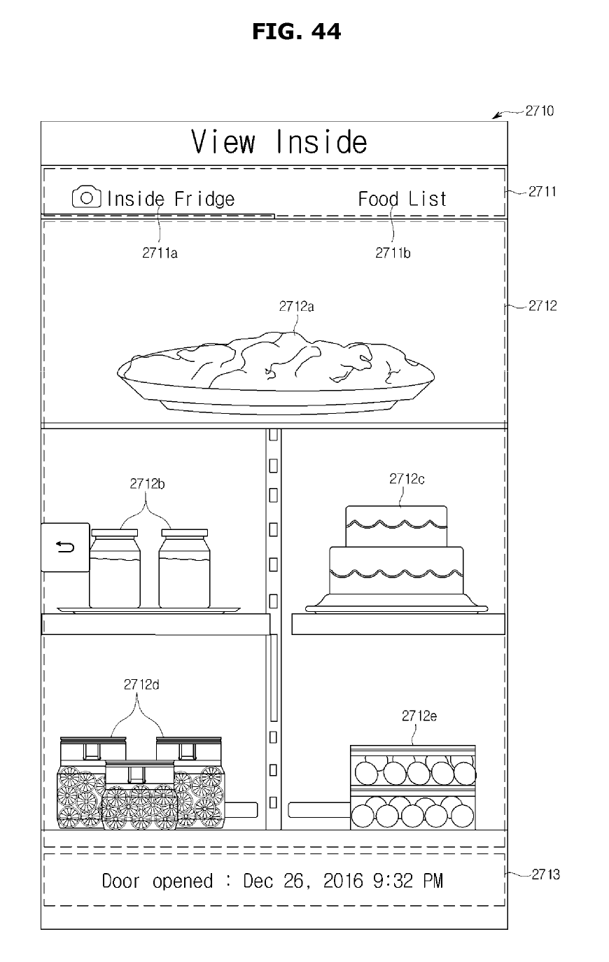

FIG. 43 illustrates a method of generating and displaying a food list by the refrigerator according to one embodiment. FIGS. 44, 45, 46, 47, and 48 illustrate screens for generating and displaying a food list according to the method of generating and displaying a food list illustrated in FIG. 43.

The users may add food stored in the storage compartment 20 by using the view-inside application of the refrigerator 1, and the refrigerator 1 may display a list of food stored in the storage compartment 20.

A food list generating/displaying method (1700) in which the refrigerator 1 generates and displays a food list will be described with reference to FIGS. 43, 44, 45, 46, 47, and 48.

The refrigerator 1 determines whether food is additionally stored (1710).

The refrigerator 1 may monitor whether new food is additionally stored in the storage compartment 20 to manage foods stored in the storage compartment 20.

The refrigerator 1 may use various methods to monitor whether new food is additionally stored. For example, the refrigerator 1 may determine that new food is additionally stored in the storage compartment 20 when the door 30 is opened and then closed.

As another example, when the view-inside GUI elements 2017 and 2027 of the home screens 2010 and 2020 are touched by the user, the refrigerator 1 may determine that new food is additionally stored. In response to touch inputs made on the view-inside GUI elements 2017 and 2027, the refrigerator 1 may run the view-inside application. The refrigerator 1 may capture foods stored in the storage compartment 20 by running the view-inside application and manage the foods on the basis of the captured images of the foods.

The refrigerator 1 captures an inside of the storage compartment (1720) and displays the captured storage compartment image (1730).

When the door 30 is opened and then closed, the refrigerator 1 may run the view-inside application. Through the view-inside application, the refrigerator 1 may capture the inside of the storage compartment 20 and display the captured image of the storage compartment 20.

The refrigerator 1 may use the camera 190 to capture the inside of the storage compartment 20. The camera 190 may be installed in each of the plurality of storage compartments 20a, 20b, and 20c and capture the inside of each of the plurality of storage compartments 20a, 20b, and 20c. The plurality of cameras 190 may be installed in the upper storage compartment 20a having a high storage capacity, and the plurality of cameras 190 may capture the entire upper storage compartment 20a.

The refrigerator 1 may display the image of the inside of the storage compartment 20 captured using the camera 190 on the touchscreen display 120. Because various types of foods are stored in the storage compartment 20, the image of the inside of the storage compartment 20 may include images of various types of foods stored in the storage compartment 20.

The refrigerator 1 may display a food management screen 2710 including an image of the inside of the storage compartment 20 as illustrated in FIG. 44.

The food management screen 2710 may include a display selection region 2711 for selecting a display of the image of the inside of the storage compartment 20, an image display region 2712 in which the image of the inside of the storage compartment 20 is displayed, and a capture time display region 2713 in which the time at which the image of the inside of the storage compartment 20 is captured is displayed.

An image display tab 2711a for displaying the image of the inside of the storage compartment 20 and a list display tab 2711b for displaying a list of foods stored in the storage compartment 20 may be displayed in the display selection region 2711.

When the image display tab 2711a is selected, images of foods 2712a, 2712b, 2712c, 2712d, and 2712e may be displayed in the image display region 2712 of the food management screen 2710. For example, the images of a first food 2712a, a second food 2712b, a third food 2712c, a fourth food 2712d, and a fifth food 2712e may be displayed in the image display region 2712.

The refrigerator 1 receives selection on new food from the user (1740).

The user may check the images of the foods 2712a, 2712b, 2712c, 2712d, and 2712e displayed on the food management screen 2710 and select food added to the storage compartment 20 among the displayed foods 2712a, 2712b, 2712c, 2712d, and 2712e. For example, the user may touch the image of the first food 2712a among the images of the foods 2712a, 2712b, 2712c, 2712d, and 2712e displayed on the food management screen 2710.

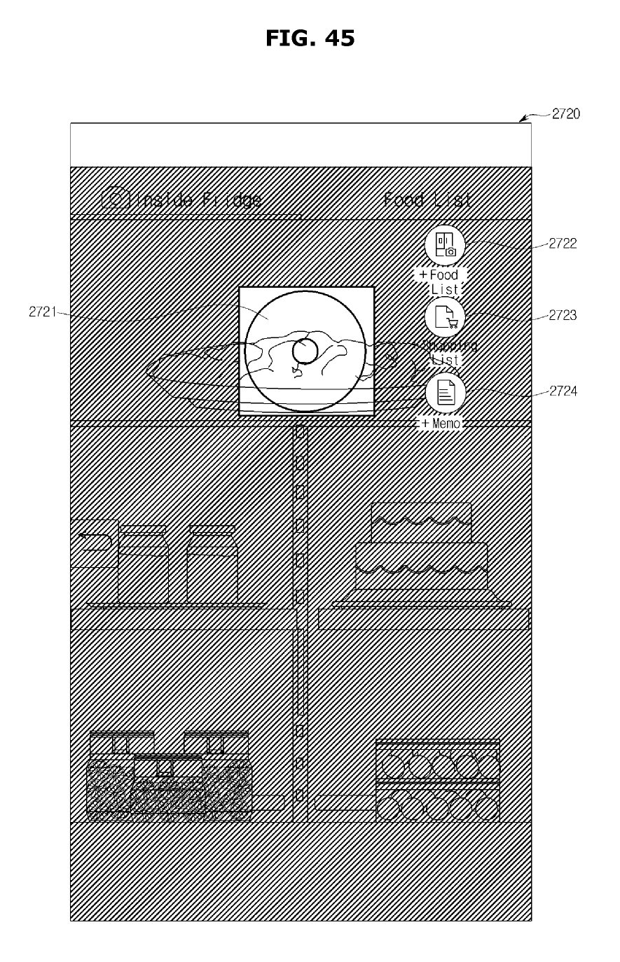

When a touch input is made on the image of the first food 2712a, the refrigerator 1 may display a food adding screen 2720 as illustrated in FIG. 45.

A food image display region 2721 in which food selected by the user is displayed, a food list adding button 2722 for adding the food selected by the user to a food list, a shopping list adding button 2723 for adding the food selected by the user to a shopping list, and a memo adding button 2724 for generating a memo related to the food selected by the user may be displayed on the food adding screen 2720.

For example, when the user touches the image of the first food 2712a, the refrigerator 1 may display the image of the first food 2712a in the food image display region 2721. When the user touches the food list adding button 2722, the refrigerator 1 may add the first food 2712a to a food list. When the user touches the shopping list adding button 2723, the refrigerator 1 may add the first food 2712a to a shopping list. When the user touches the memo adding button 2724, the refrigerator 1 may generate a memo using the image of the first food 2712a.

When food is added, the refrigerator 1 displays a food list (1750).

When food is added to the food list through the food adding screen 2720, the refrigerator 1 may display the food list including the added food.

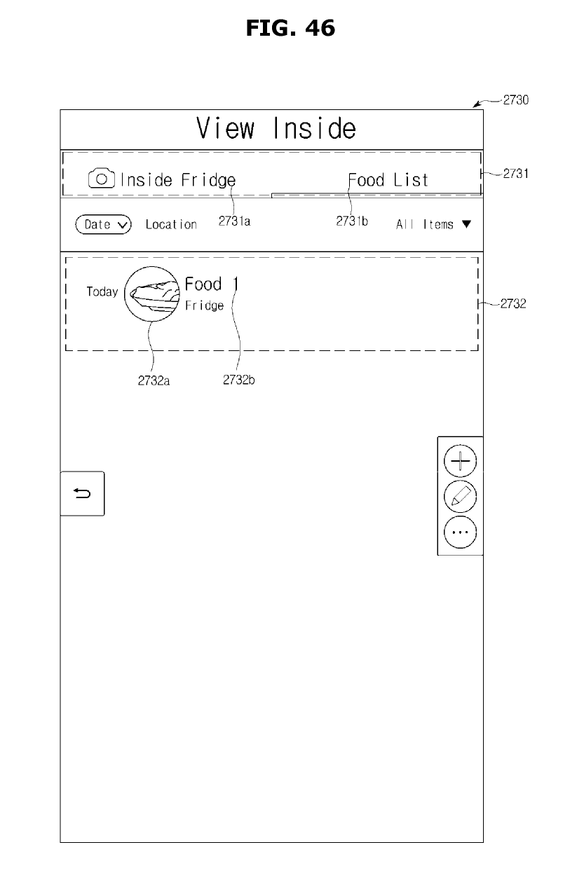

When a touch input is made on the list display tab 2711b of the food adding screen 2720, the refrigerator 1 may display a food management screen 2730 as illustrated in FIG. 46.

The food management screen 2730 may include a display selection region 2731 for selecting a display of a list of foods stored in the storage compartment 20 and a list display region 2732 in which a list of foods stored in the storage compartment 20 is displayed.

An image display tab 2731a for displaying an image of the inside of the storage compartment 20 and a list display tab 2731b for displaying a list of foods stored in the storage compartment 20 may be displayed in the display selection region 2731.

When the list display tab 2731b is selected, a list of foods stored in the storage compartment 20 may be displayed in the list display region 2732 of the food management screen 2730. For example, an image 2732a of a first food stored in the storage compartment 20 and a name 2732b of the first food stored in the storage compartment 20 may be displayed in the list display region 2732.

The refrigerator 1 may display food images and a food list for managing foods through the food management screens 2710 and 2730. The user may manage foods stored in the refrigerator 1 by using the food management screens 2710 and 2730 of the refrigerator 1.

Then, the refrigerator 1 transmits the food images and the food list to the service server 3 (1760), and the service server 3 transmits the received food images and food list to the user device 2 (1770).

When the food images and the food list are received from the refrigerator 1, the service server 3 may store the received food images and food list and transmit the food images and the food list to the user device 2.

The user device 2 displays the received food images (1780).

In response to reception of the food images from the service server 3, the user device 2 may display an image of the inside of the refrigerator 1 on the touchscreen display 220.

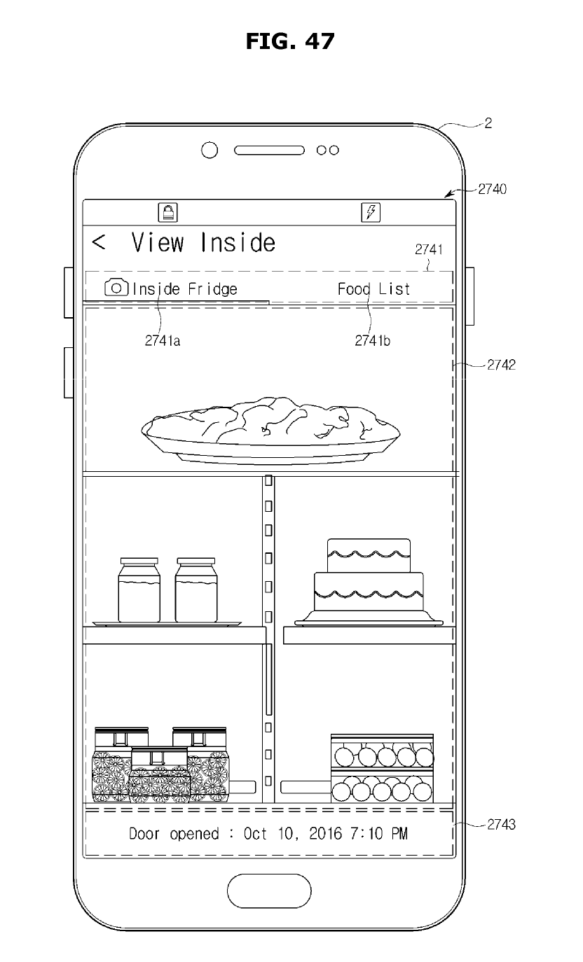

The user device 2 may display a food management screen 2740 including the image of the inside of the refrigerator 1 as illustrated in FIG. 47.

The food management screen 2740 may include a display selection region 2741 for selecting a display of the image of the inside of the refrigerator 1, an image display region 2742 in which the image of the inside of the refrigerator 1 is displayed, and a capture time display region 2743 in which the time at which the image of the inside of the refrigerator 1 is captured is displayed.

An image display tab 2741a for displaying an image of the inside of the refrigerator 1 and a list display tab 2741b for displaying a list of foods stored in the refrigerator 1 may be displayed in the display selection region 2741.

When the image display tab 2741a is selected, images of foods stored in the refrigerator 1 may be displayed in the image display region 2742 of the food management screen 2740.

The user device 2 displays the received food list (1790).

In response to reception of the food list from the service server 3, the user device 2 may display the list of foods stored in the refrigerator 1 on the touchscreen display 220.

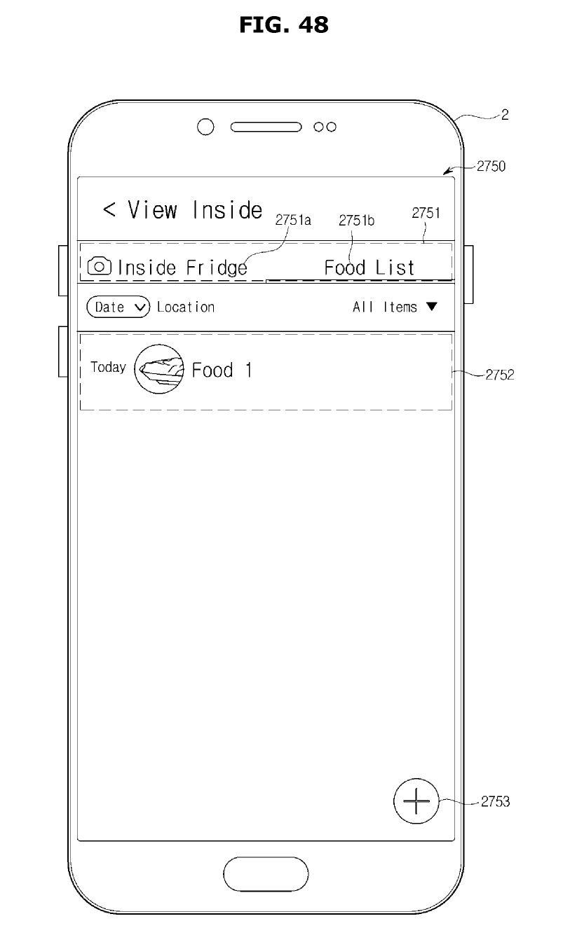

The user device 2 may display a food management screen 2750 including a list of foods stored in the refrigerator 1 as illustrated in FIG. 48.

The food management screen 2750 may include a display selection region 2751 for selecting a display of a list of foods stored in the refrigerator 1 and a list display region 2752 in which the list of foods stored in the refrigerator 1 is displayed.

An image display tab 2751a for displaying an image of the inside of the refrigerator 1 and a list display tab 2751b for displaying a list of foods stored in the refrigerator 1 may be displayed in the display selection region 2751.

When the list display tab 2751b is selected, the list of foods stored in the refrigerator 1 may be displayed in the list display region 2752 of the food management screen 2750.

A food adding button 2753 for adding food may be displayed on the food management screen 2750. The user may touch the food adding button 2753 to add new food.

The user device 2 may display food images and a food list for managing foods through the food management screens 2740 and 2750. The user may manage foods stored in the refrigerator 1 by using the food management screens 2740 and 2750 of the user device 2.

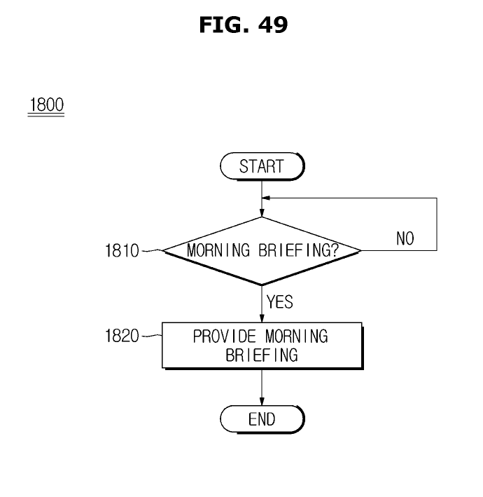

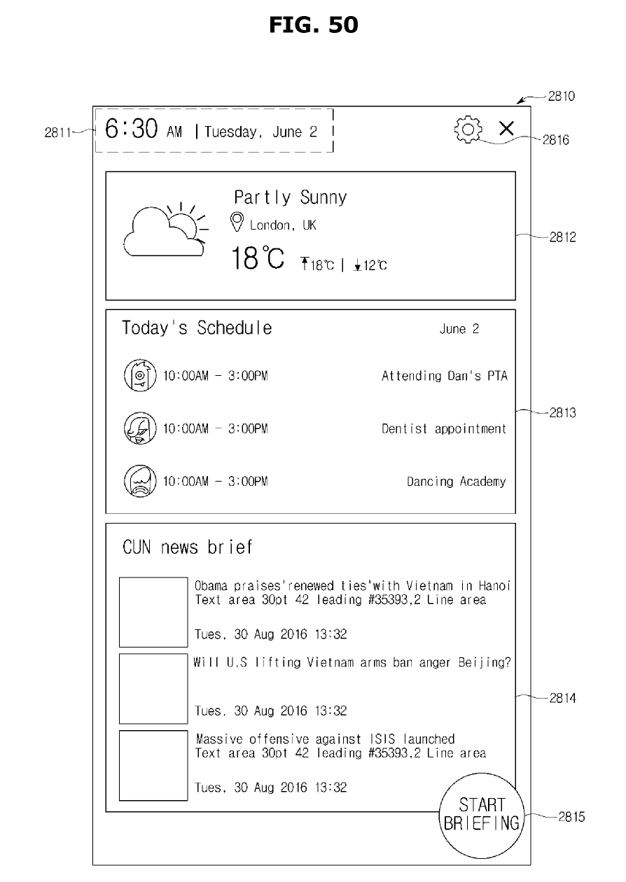

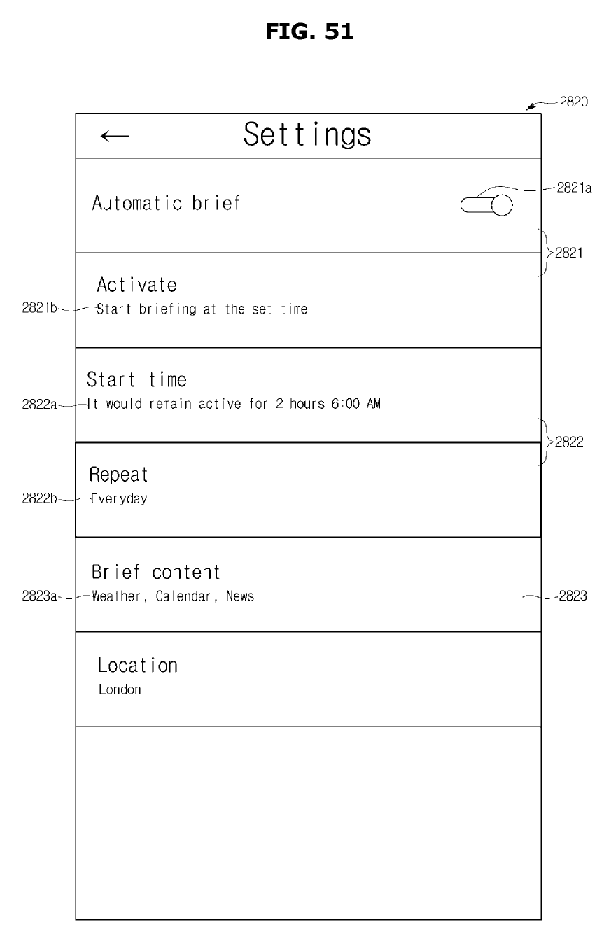

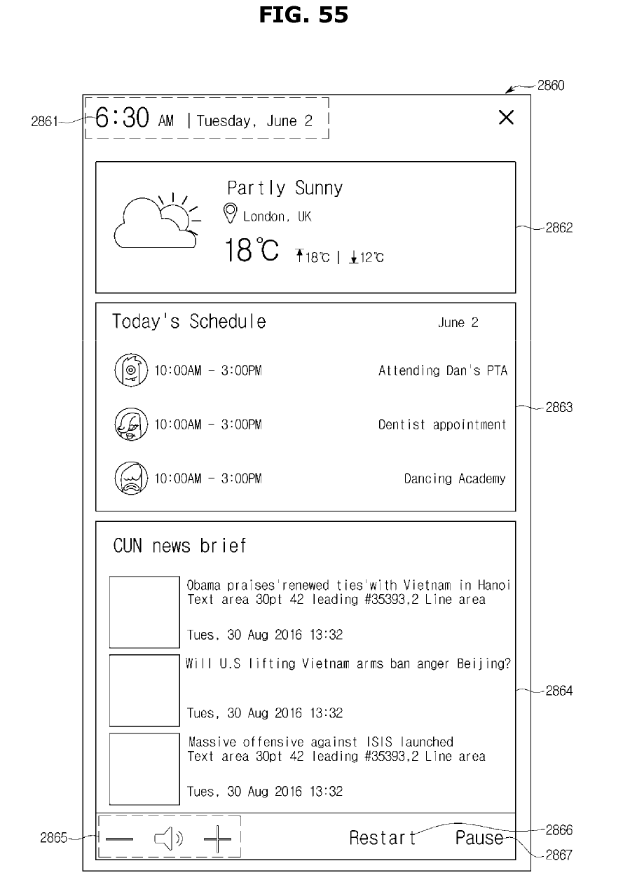

FIG. 49 illustrates a method of providing morning briefing by the refrigerator according to one embodiment. FIG. 50 illustrates a morning briefing display screen displayed on the touchscreen display included in the refrigerator according to one embodiment. FIGS. 51, 52, 53, and 54 illustrate screens for setting morning briefing of the refrigerator according to one embodiment. FIG. 55 illustrates a morning briefing output screen for outputting morning briefing by the refrigerator according to one embodiment.

The refrigerator 1 may provide morning briefing including weather, schedule, and/or news according to a user's settings.

A morning briefing method (1800) in which the refrigerator 1 provides morning briefing to a user will be described with reference to FIGS. 49, 50, 51, 52, 53, 54, and 55.

The refrigerator 1 determines whether to provide morning briefing (1810).

When a briefing condition preset by the user is satisfied, the refrigerator 1 may provide morning briefing. For example, the refrigerator 1 may provide morning briefing at a time preset by the user.

The user may run the morning briefing application and set a briefing condition. For example, the user may make touch inputs on the morning briefing GUI elements 2019 and 2029 displayed on the home screens 2010 and 2020. When the touch inputs are made on the morning briefing GUI elements 2019 and 2029, the refrigerator 1 may display a morning briefing screen 2810 illustrated in FIG. 50.

The morning briefing screen 2810 may include a date/time display region 2811 in which a date and time are displayed, briefing regions 2812, 2813, and 2814 in which pieces of briefing content set by the user are displayed, a voice briefing start button 2815 for starting voice briefing, and a briefing setting button 2816 for setting briefing content.

Pieces of briefing content set by the user may be displayed in the briefing regions 2812, 2813, and 2814. For example, as illustrated in FIG. 50, weather content 2812, schedule content 2813, and news content 2814 may be respectively displayed in the briefing regions 2812, 2813, and 2814.

When the voice briefing start button 2815 of the morning briefing screen 2810 is touched, the refrigerator 1 may start voice briefing. For example, during the voice briefing, the refrigerator 1 may output text and/or numbers in the pieces of briefing contents respectively displayed in the briefing regions 2812, 2813, and 2814 by voice. In other words, during the voice briefing, the refrigerator 1 may read the pieces of briefing content out loud. When the voice briefing start button 2815 is touched, the refrigerator 1 may display a morning briefing screen 2860, which will be described below, as illustrated in FIG. 55.

When the briefing setting button 2816 of the morning briefing screen 2810 is touched, the refrigerator 1 may display a screen for setting parameters related to morning briefing. For example, the refrigerator 1 may display a briefing setting screen 2820 as illustrated in FIG. 51.

The briefing setting screen 2820 may include an automatic briefing setting region 2821 for setting automatic briefing, a briefing start setting region 2822 for setting conditions for starting briefing, and a briefing content setting region 2823 for setting content to be briefed.

An automatic briefing activation button 2821a for activating or deactivating the automatic briefing may be displayed in the automatic briefing setting region 2821. The user may touch the automatic briefing activation button 2821a to activate or deactivate automatic briefing.

When automatic briefing is activated, the refrigerator 1 may automatically provide morning briefing to the user in response to satisfaction of briefing conditions.

When automatic briefing is activated by the automatic briefing activation button 2821a, the refrigerator 1 may display a voice briefing activation screen 2830 for setting whether voice briefing is performed at the start of briefing.

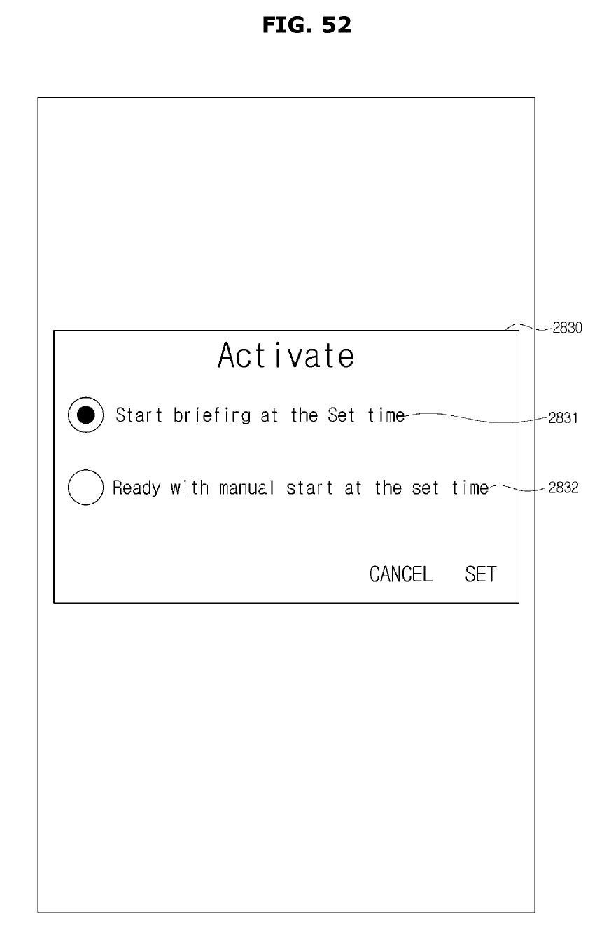

For example, as illustrated in FIG. 52, a voice briefing activation button 2831 for activating voice briefing and a voice briefing deactivation button 2832 for deactivating voice briefing may be displayed on the voice briefing activation screen 2830. When voice briefing is activated, the refrigerator 1 may automatically start voice briefing upon the start of morning briefing. When voice briefing is deactivated, the refrigerator 1 may suspend voice briefing upon the start of morning briefing and display only the morning briefing screen.

A start time setting region 2822a for setting/displaying a start time of morning briefing, and a weekly repetition setting region 2822b for setting/displaying the number of repetitions of morning briefing per week may be displayed in the briefing start setting region 2822. The user may touch the start time setting region 2822a and input the time (for example, 6 AM) for starting morning briefing. The user may touch the weekly repetition setting region 2822b and input the number of repetitions of morning briefing per week (for example, repeat everyday or repeat on Monday/Tuesday/Wednesday/Thursday/Friday).

Pieces of content 2823a indicating content to be briefed by morning briefing may be displayed in the briefing content setting region 2823. The user may touch the briefing content setting region 2823 to set content to be briefed.

When a touch input is made on the briefing content setting region 2823, the refrigerator 1 may display a content selection screen 2840 for selecting briefing content.

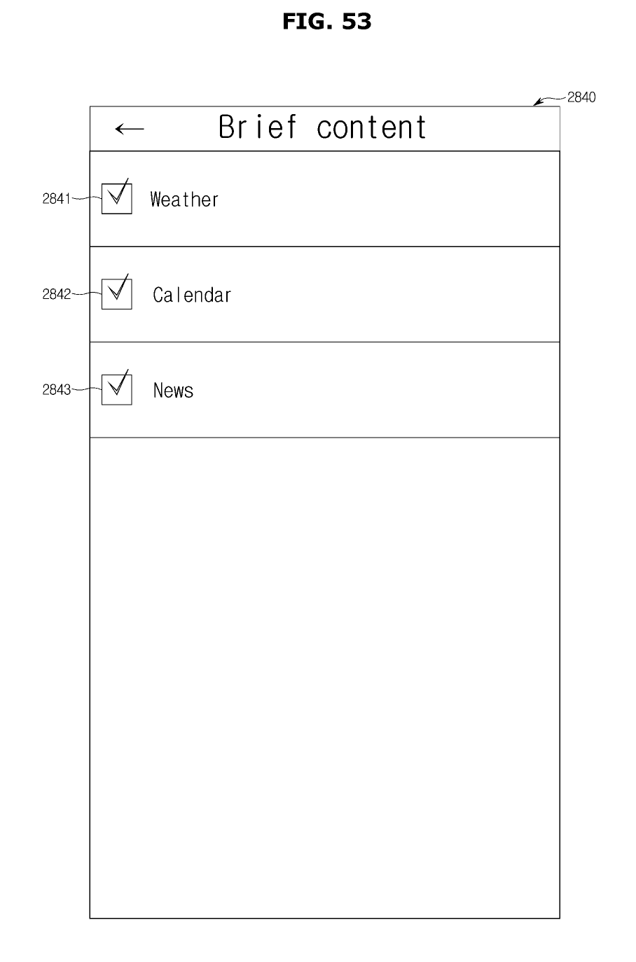

For example, as illustrated in FIG. 53, pieces of content 2841, 2842, and 2843 that may be selected by the user may be displayed on the content selection screen 2840. For example, the content selection screen 2840 may include a weather content checkbox 2841 for selecting weather content, a schedule content checkbox 2842 for selecting schedule content, and a news content checkbox 2843 for selecting news content. The user may check at least one of the plurality of checkboxes 2841, 2842, and 2843 displayed on the content selection screen 2840.

When briefing content is selected through the content selection screen 2840, the refrigerator 1 may display the selected content on the morning briefing screen 2810.

When it is determined to provide morning briefing (YES to 1810), the refrigerator 1 provides morning briefing to the user (1820).

When a briefing condition (for example, a briefing start time) set by the user through the briefing setting screen 2820 is satisfied, the refrigerator 1 may display a screen for morning briefing on the touchscreen display 120.

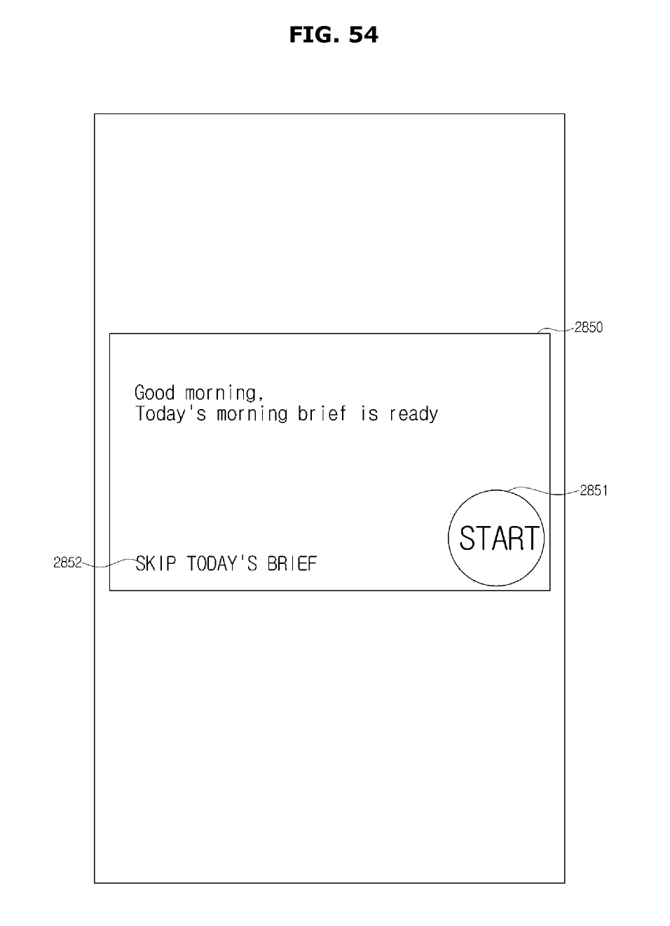

For example, when voice briefing is deactivated by the voice briefing deactivation button 2832 of the voice briefing activation screen 2830, the refrigerator 1 may display a morning briefing start screen 2850 as illustrated in FIG. 54.

The morning briefing start screen 2850 may include a voice briefing start button 2851 for starting voice briefing and a voice briefing skip button 2852 for skipping voice briefing.

When a touch input is made on the briefing start button 2851, the refrigerator 1 may display content for morning briefing on the touchscreen display 120 and output sound related to briefing content through the audio 180.

For example, the refrigerator 1 may display the morning briefing screen 2860 as illustrated in FIG. 55 on the touchscreen display 120. The morning briefing screen 2860 may include a date/time display region 2861 and briefing regions 2862, 2863, and 2864. The refrigerator 1 may output pieces of content displayed in the briefing regions 2862, 2863, and 2864 by sound or voice through the audio 180.

A volume control button 2865 for controlling volume of sound output through the audio 180, a pause button 2867 for pausing an output of briefing content by sound, and a briefing resume button 2866 for resuming output of the briefing content by sound may be displayed on the morning briefing screen 2860. The user may control volume of voice briefing using the volume control button 2865. The user may pause voice briefing using the pause button 2867 and resume voice briefing using the briefing resume button 2866.

As described above, the refrigerator 1 may provide morning briefing including content selected by the user.

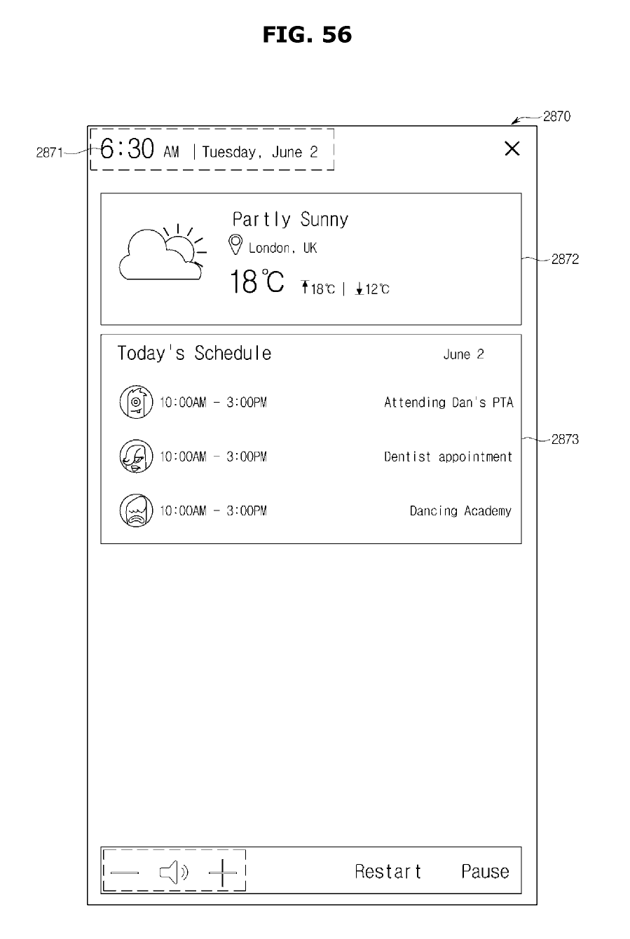

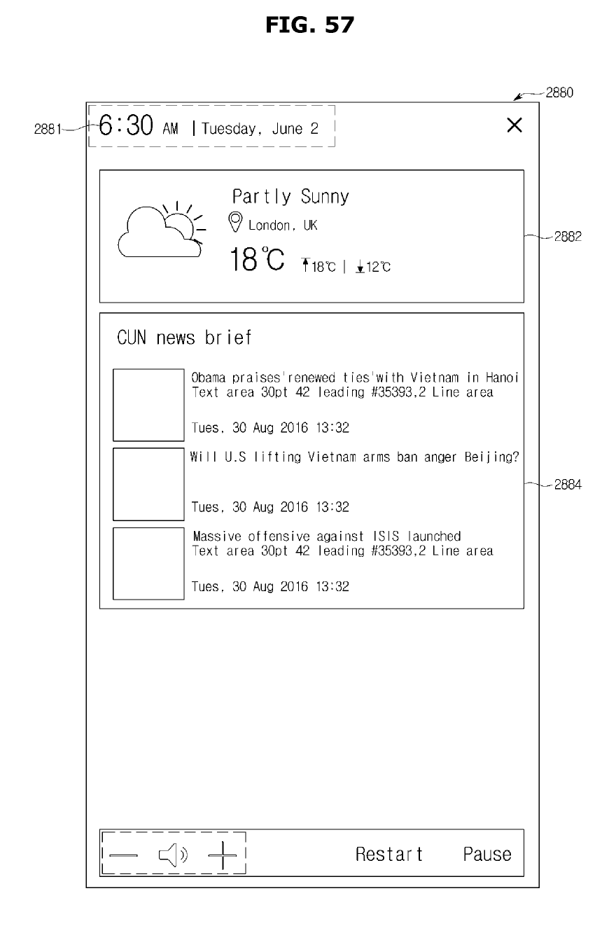

FIGS. 56 and 57 illustrate other examples of a briefing display screen displayed on the touchscreen display included in the refrigerator according to one embodiment.

As described above, the refrigerator 1 may identify a user using speaker recognition, facial recognition, fingerprint recognition, iris recognition, vein recognition, and the like and display different home screens 2010 and 2020 according to an identified user.

The refrigerator 1 may identify a user and provide different morning briefing according to an identified user. Specifically, the refrigerator 1 may provide morning briefing including content selected by the identified user.

For example, when the identified user is the second user USER2, the refrigerator 1 may provide morning briefing including content selected by the second user USER2. When the second user USER2 selected weather content and schedule content through the content selection screen 2840 (see FIG. 53), the refrigerator 1 may display a morning briefing screen 2870 as illustrated in FIG. 56. A date/time 2871, weather content 2872, and schedule content 2873 may be displayed on the morning briefing screen 2870. The refrigerator 1 may output the weather content 2872 and the schedule content 2873 by sound through the audio 180.

As another example, when the identified user is the third user USER3, the refrigerator 1 may provide morning briefing including content selected by the third user USER3. When the third user USER3 selected weather content and news content, the refrigerator 1 may display a morning briefing screen 2880 as illustrated in FIG. 57. A date/time 2881, weather content 2882, and news content 2884 may be displayed on the morning briefing screen 2880. The refrigerator 1 may output the weather content 2882 and the news content 2884 by sound through the audio 180.

As described above, the refrigerator 1 may identify a current user and provide morning briefing having different pieces of content for different users.

As is apparent from the above description, according to an aspect of the disclosure, content customized for each of a plurality of users can be provided by using a communication device and a touchscreen display linked to user devices of the plurality of users.

According to another aspect of the disclosure, a refrigerator capable of providing different pieces of content to different users by using a communication device and a touchscreen display can be provided.

The embodiments disclosed herein may be implemented in the form of a recording medium that stores a computer executable command. The command may be stored in the form of a program code, and when executed by a processor, may generate a program module and perform operations of the embodiments disclosed herein. The recording medium may be implemented as a computer readable recording medium.

The computer readable recording medium includes all types of recording media in which computer readable commands are stored. Examples of the computer readable medium may include a ROM, a RAM, a magnetic tape, a magnetic disk, a flash memory, an optical data storage device, and the like.

Embodiments disclosed herein have been described above with reference to the accompanying drawings. One of ordinary skill in the art to which the embodiments disclosed herein pertain should understand that the embodiments may be practiced in different forms from the above without changing the technical spirit or essential features of the embodiments. The embodiments are merely illustrative and should not be interpreted as limiting.

What is claimed is:

1. A refrigerator comprising:
a touchscreen display configured to receive a touch input from a plurality of users and display content in response to the touch input;
a storage configured to store content for each of the plurality of users; and
a controller configured to sense any one of the plurality of users and, display content for the user on the touchscreen display in response to the sensing of the user,
wherein, the controller displays a different piece of content on the touchscreen display in response to sensing of another user.

2. The refrigerator of claim 1, further comprising a microphone configured to receive a voice signal of the plurality of users and output an electrical signal corresponding to the voice signal,
wherein the controller identifies any one of the plurality of users on the basis of the electrical signal from the microphone.

3. The refrigerator of claim 1, wherein the content includes memos, recipients of the memos, and senders of the memos, and
the controller displays a memo of which a recipient or sender matches the user on the touchscreen display in response to the sensing of the user.

4. The refrigerator of claim 1, wherein the content includes things to do and performers of the things to do, and
the controller displays things to do of which a performer matches the user on the touchscreen display in response to the sensing of the user.

5. The refrigerator of claim 1, wherein the content includes sketches and writers of the sketches, and
the controller displays a sketch of which a writer matches the user on the touchscreen display in response to the sensing of the user.

6. The refrigerator of claim 1, wherein the content includes schedules, writers of the schedules, and participants in the schedules, and
the controller displays a schedule of which a writer or a participant matches the user on the touchscreen display in response to the sensing of the user.

7. The refrigerator of claim 1, wherein the content includes at least one of weather information, schedule information, and news information, and
the controller displays a piece of content selected by the user among the weather information, the schedule information, and the news information on the touchscreen display in response to the sensing of the user.

8. The refrigerator of claim 7, further comprising an audio configured to output sound,
wherein the controller controls the audio to output content selected by the user by sound.

9. The refrigerator of claim 1, further comprising a communicator configured to communicate with a user device of each of the plurality of users,
wherein the controller transmits pieces of content for the plurality of users to the user devices of the plurality of users through the communicator.

10. The refrigerator of claim 9, wherein the controller transmits a different piece of content to a user device of another user through the communicator.

11. A refrigerator comprising:
a touchscreen display configured to display an image in response to a touch input of a first user and display content in response to a touch input of a second user;
a storage configured to store user information of the first user and user information of the second user; and
a controller configured to generate content related to the second user according to the touch input of the first user and display the user information of the second user and the content related to the second user on the touchscreen display.

12. The refrigerator of claim 11, wherein the controller further generates content related to the first user according to the touch input of the first user and displays the content related to the second user and the content related to the first user on the touchscreen display in response to sensing of the first user or the second user.

13. The refrigerator of claim 11, wherein the controller generates content related to the first user according to the touch input of the first user, displays the content related to the first user in response to sensing of the first user, and displays content related to the second user in response to sensing of the second user.

14. The refrigerator of claim 11, further comprising a communicator configured to communicate with a user device of the first user on the basis of the user information of the first user and communicate with a user device of the second user on the basis of the user information of the second user,
wherein the controller generates content related to the first user according to the touch input of the first user and transmits the content related to the first user and the content related to second user to the user device of the first user and the user device of the second user.

15. The refrigerator of claim 11, further comprising a communicator configured to communicate with a user device of the first user on the basis of the user information of the first user and communicate with a user device of the second user on the basis of the user information of the second user,
wherein the controller generates content related to the first user according to the touch input of the first user, transmits the content related to the first user to the user device of the first user, and transmits the content related to the second user to the user device of the second user.

16. A method of controlling a refrigerator, the method comprising:
receiving a touch input from a first user;
generating content related to a second user according to the touch input; and
displaying a user image showing the first user, a user image showing the second user, and the content related to the second user.

17. The method of claim 16, further comprising:
generating content related to the first user according to the touch input of the first user; and
displaying the content related to the second user and the content related to the first user in response to sensing of the first user or the second user.

18. The method of claim 16, further comprising:
generating content related to the first user according to the touch input of the first user;
displaying the content related to the first user in response to sensing of the first user; and
displaying the content related to the second user in response to sensing of the second user.

19. The method of claim 16, further comprising:
generating content related to the first user according to the touch input of the first user; and
transmitting the content related to the first user and the content related to the second user to a user device of the first user and a user device of the second user.

20. The method of claim 16, further comprising:
generating content related to the first user according to the touch input of the first user;
transmitting the content related to the first user to a user device of the first user; and
transmitting the content related to the second user to a user device of the second user.
